(19) United States
(12) Patent Application Publication
(10) Pub. No.: US 2025/0272422 A1
(43) Pub. Date: Aug. 28, 2025

(54) DEDUPLICATING ROLE-BASED ACCESS CONTROL POLICIES USING SYMBOLIC ABSTRACTION MODELS AND SATISFIABILITY SOLVER MODELS

(71) Applicant: Microsoft Technology Licensing, LLC, Redmond, WA (US)

(72) Inventors: Siva Kesava Reddy KAKARLA, Redmond, WA (US); Rathin SINGHA, Los Angeles, CA (US); Ryan Andrew BECKETT, Redmond, WA (US); Nikolaj Skallerud BJORNER, Woodinville, WA (US); Behnaz ARZANI, Woodinville, WA (US); Barry John TURNER, Seattle, WA (US); Kiran Kumar DOWLURU, Bellevue, WA (US)

(21) Appl. No.: 18/615,785

(22) Filed: Mar. 25, 2024

Related U.S. Application Data
(60) Provisional application No. 63/558,003, filed on Feb. 26, 2024.

(51) Int. Cl. G06F 21/62

(52) U.S. Cl. CPC G06F 21/6218

(57) ABSTRACT

This disclosure describes a policy deduplication system that determines duplicates among a set of RBAC policies. For instance, the policy deduplication system determines whether a pair of RBAC policies within a cloud computing system are semantically equivalent, even if they are syntactically distinct. In addition, the policy deduplication system utilizes symbolic abstraction models and satisfiability solver models to identify duplicate policies that are semantically equal for all user inputs by searching for counterexamples that would prove a pair of policies to be semantically unequal. However, if no counterexamples are found, the policy deduplication system determines that the policies are duplicates.

### CROSS-REFERENCE TO RELATED APPLICATIONS

This application claims benefit and priority to U.S. Provisional Application No. 63/558,003, entitled VALIDATING, DEDUPLICATING, AND TESTING ROLE-BASED ACCESS CONTROL POLICIES USING SYMBOLIC ABSTRACTION MODELS AND SATISFIABILITY SOLVER MODELS, and filed on Feb. 26, 2024.

### BACKGROUND

Recent years have seen significant technological advances in both hardware and software in the field of cloud computing systems. More than ever, systems and entities are using cloud computing systems to access the ever-growing resources and services they provide. Many cloud computing systems employ Role-Based Access Control (RBAC) policies to determine whether to grant access requests.

RBAC policies provide cloud computing systems with security measures to prevent unauthorized access. However, due to the complexities and interdependencies involved in implementing RBAC policies, existing systems often have undetected vulnerabilities in their policies. For example, some existing systems unknowingly include invalid policies that include dead actions or empty actions, while others allow the type of access that they were intended to prevent. Some existing systems also have policies that behave differently when implemented on different system types.

Another issue is that many existing systems are burdened with redundant policies, leading to additional problems. For instance, a cloud computing system wastes computing resources by executing each policy for every received request, even though many of the policies serve the same function. Moreover, since processing the set of policies for requests is computationally expensive, many cloud computing systems limit the number of policies. However, maintaining functionally equivalent policies not only wastes storage space but also prevents the inclusion of other important policies in a set.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of a Role-Based Access Control (RBAC) management system that uses various policy systems (e.g., a policy validation system, a policy deduplication system, and a policy consistency system) and models (e.g., a symbolic abstraction model and a satisfiability solver model) to improve the efficiency and accuracy of RBAC policies in a cloud computing system.

FIG. 2 illustrates an example overview of a policy validation system to determine the validity of RBAC policies.

FIG. 3 illustrates an example computing environment where the policy validation system is implemented.

FIG. 4 illustrates an example diagram of a user gaining unauthorized access due to an invalid policy.

FIGS. 5A-5C illustrate example diagrams for using the policy validation system to determine invalid policies.

FIG. 6 illustrates an example diagram of the policy validation system detecting that the policy of FIG. 4 is invalid.

FIG. 7 illustrates an example diagram of the policy validation system determining property violations in a set of RBAC policies.

FIG. 8 illustrates an example series of acts in a computer-implemented method for validating one or more RBAC policies.

FIG. 9 illustrates an example overview of a policy deduplication system to determine equivalent RBAC policies.

FIG. 10 illustrates an example computing environment where the policy deduplication system is implemented.

FIG. 11 illustrates an example of a pair of RBAC policy to be compared for equivalence.

FIGS. 12A-12D illustrate example diagrams of breaking down the pair RBAC policies to be compared for equivalence.

FIGS. 13A-13D illustrate example diagrams for using the policy deduplication system to determine duplicate policies.

FIG. 14 illustrates an example diagram of the policy deduplication system determining when to use a deterministic finite automaton (DFA) equivalence algorithm to test for duplicate policies.

FIG. 15 illustrates an example series of acts in a computer-implemented method for determining policy equivalence in RBAC policies.

FIGS. 16A-16B illustrate an example overview of a policy consistency system determining whether policies will be implemented consistently across different devices, platforms, services, and environments.

FIG. 17 illustrates an example computing environment where the policy consistency system is implemented.

FIGS. 18A-18C illustrate example diagrams of determining implementation consistency for a policy.

FIGS. 19A-19B illustrate example diagrams of inconsistent policies.

FIG. 20 illustrates an example series of acts in a computer-implemented method for determining implementation consistency for one or more role-based access control (RBAC) policies.

FIG. 21 illustrates example components included within a computer system used to implement the policy validation system.

### DETAILED DESCRIPTION

This disclosure describes a Role-Based Access Control (RBAC) management framework that uses various systems and models to improve the validity, efficiency, and accuracy of RBAC policies in cloud computing systems. For example, the RBAC management framework uses a policy validation system, a policy deduplication system, and a policy consistency system to better manage RBAC policies (“policies” for short), which results in improved access control in cloud computing systems. Additionally, these systems each use symbolic abstraction models and satisfiability solver models to improve RBAC policy management.

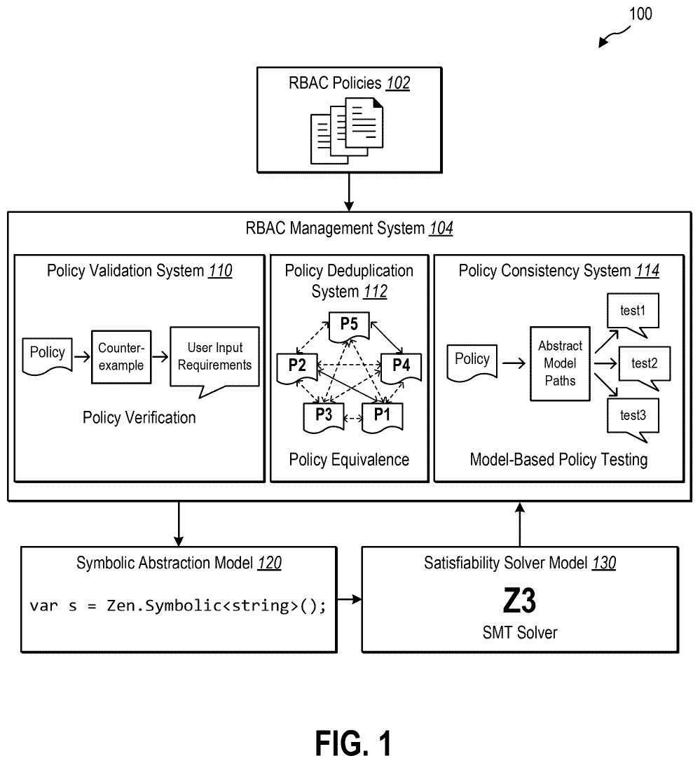

To illustrate, FIG. 1 shows an example overview 100 of an RBAC management system (i.e., the RBAC framework) that uses various policy systems and models to improve the efficiency and accuracy of RBAC policies in a cloud computing system. As shown, the RBAC management system 104 includes the policy validation system 110, the policy deduplication system 112, and the policy consistency system 114 to process and improve the management of RBAC policies 102. The RBAC management system 104 also communicates with a symbolic abstraction model 120 and a satisfiability solver model 130 to improve RBAC policy management.

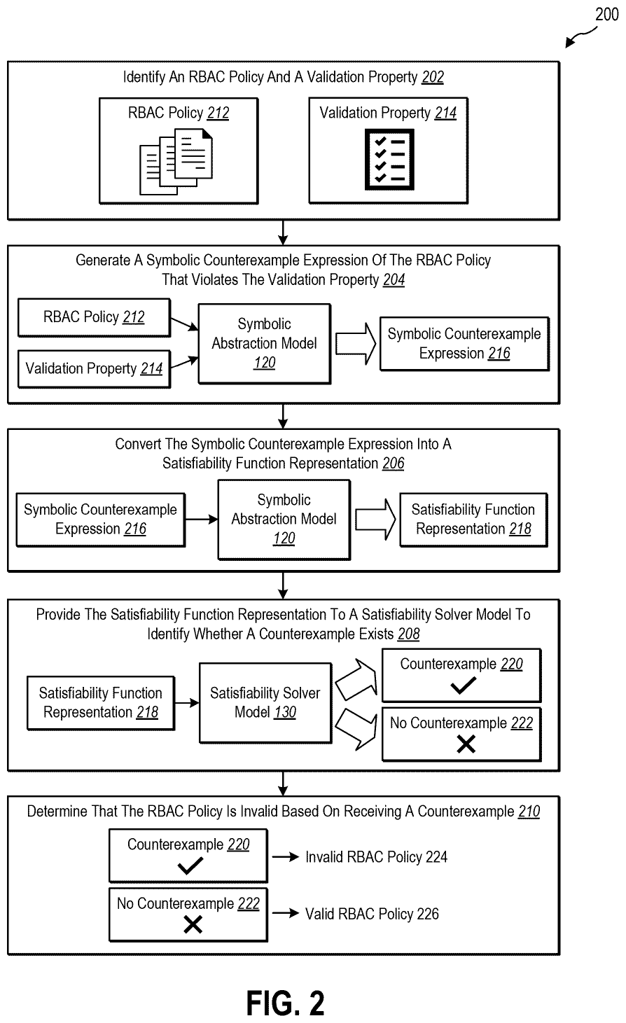

The policy validation system 110 can determine the validity of RBAC policies maintained by a cloud computing system. For example, the policy validation system 110 performs policy verification by using the symbolic abstraction model 120 and the satisfiability solver model 130 to identify counterexamples with user input requirements that violate validation properties. Additional details regarding the policy validation system 110 are provided below in connection with FIGS. 2-8.

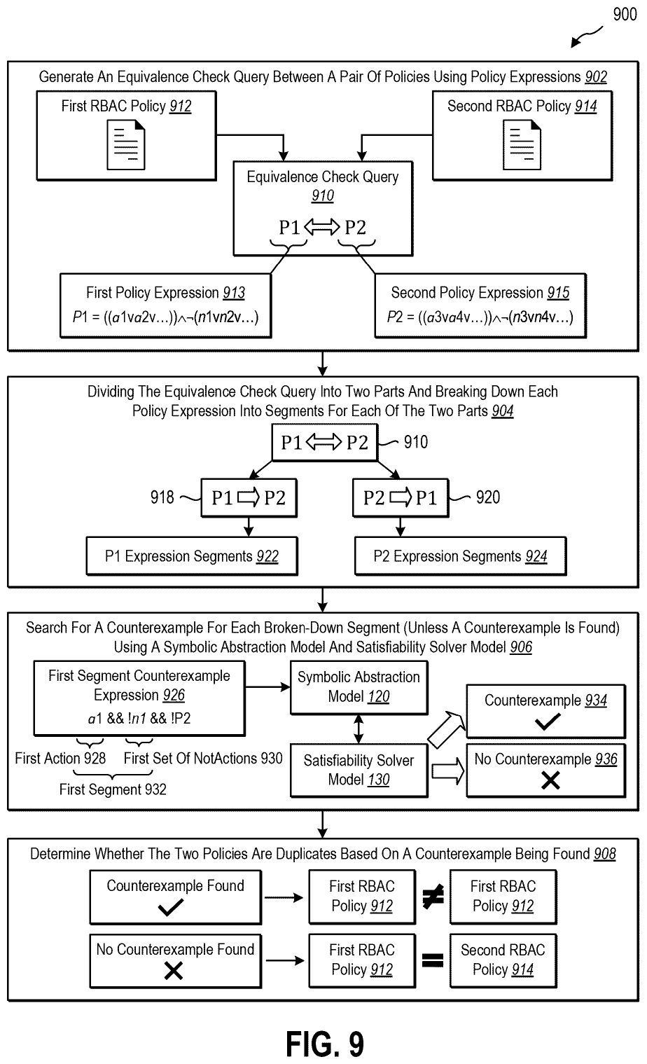

The policy deduplication system can identify semantically equivalent RBAC policies. For example, the policy deduplication system 112 uses the symbolic abstraction model 120 and the satisfiability solver model 130 to identify RBAC policies with equivalent functionality even if they have a different syntax. In various implementations, the policy deduplication system 112 breaks policies into smaller portions to more efficiently compare potentially duplicate policies. Additional details regarding the policy deduplication system 112 are provided below in connection with FIGS. 9-15.

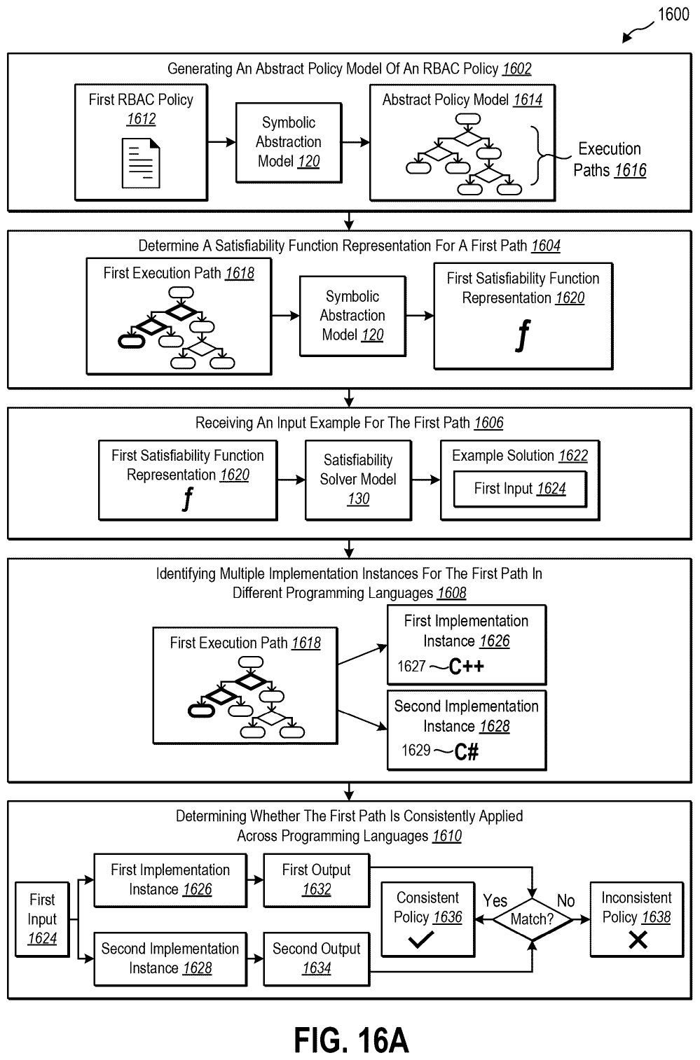

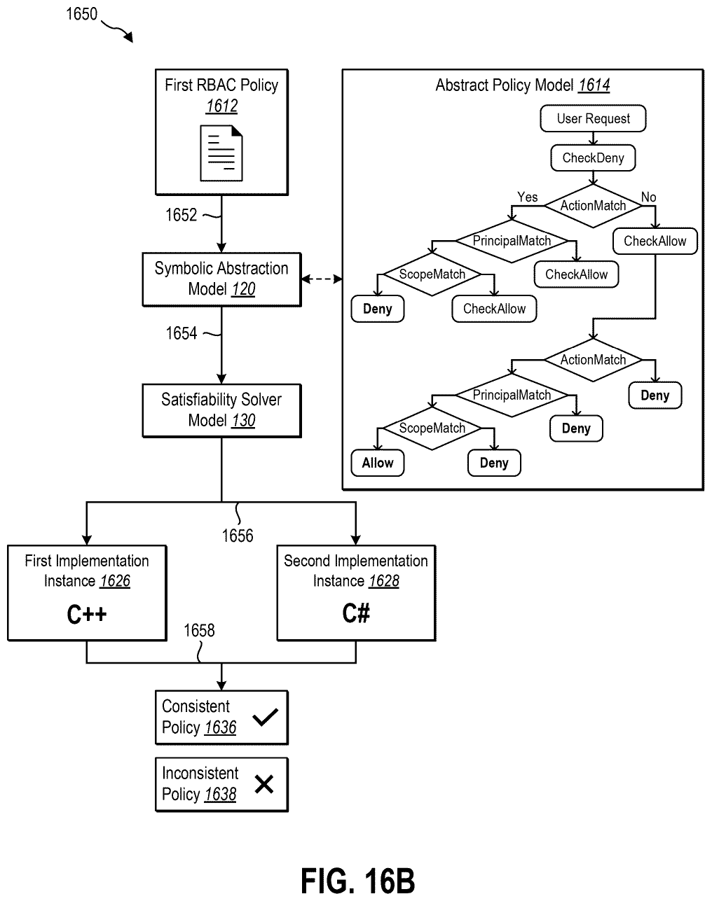

The policy consistency system 114 can determine whether a target RBAC policy performs inconsistently across different devices and implementations using the symbolic abstraction model 120, which determines available execution paths for a given policy. For some or all paths, the policy consistency system 114 uses the satisfiability solver model 130 to identify example user input requirements. The policy consistency system 114 executes the target policy with each input in different implementations to verify consistency. Additional details regarding the policy consistency system 114 are provided below in connection with FIGS. 16A-20.

Notably, while this disclosure includes different sections for the policy validation system, the policy deduplication system, and the policy consistency system, the subject matter included in one section often applies to other sections. For example, while the policy validation system section provides additional information about the creation, problems, and technical solutions regarding RBAC policies, these technical solutions often equally apply to the policy deduplication system section and the policy consistency system section. For instance, both removing invalid RBAC policies or duplicate RBAC policies, whether done by the policy validation system or the policy deduplication system, results in efficiency gains for a cloud computing system. In other words, all actions disclosed in this document, regardless of the policy system in which they are described, fall under the broader actions of the RBAC management system or framework.

By way of context, RBAC empowers systems, entities, and organizations with granular control over access to cloud computing system resources. RBAC also allows for the efficient management of different resources within cloud computing systems, such as a graphical processing unit (GPU), virtual machines (VMs), and storage. RBAC applies to all users (e.g., internal and external users) based on roles, actions, non-actions, and conditions stated in the RBAC policies. In some instances, RBAC applies to systems or entities that request resource access.

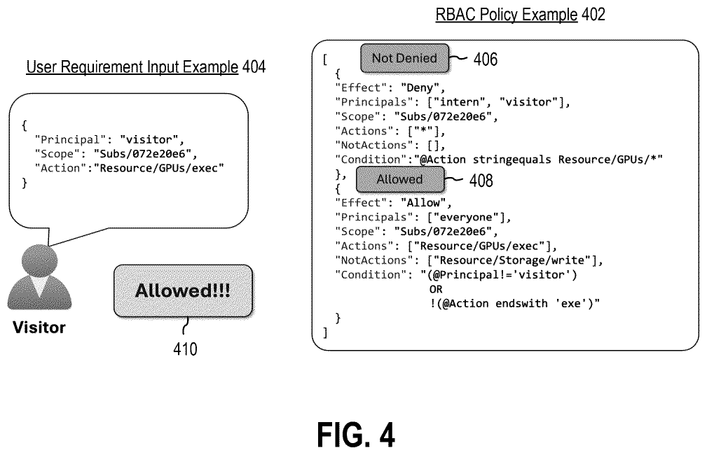

RBAC policies are often triggered by a user requesting access to a resource or service of a cloud computing system. The request includes user requirement inputs, such as a user identifier, a scope, and an action, which allows the RBAC management system to compare the request against a set of RBAC policies. An example of user requirement inputs in a user request and an RBAC policy is shown in FIG. 4, which is described below.

In some implementations, RBAC policies are segmented into three principal components: service role assignments, non-service role assignments, and deny assignments. In many cases, an RBAC management system initially checks a user request against the service role assignments segment of an RBAC policy (e.g., “allow” rules). If these rules and expressions of the service role assignments segment allow the request, the RBAC management system grants access. This part of a policy reflects the preeminence of service roles in maintaining core operational functionalities.

If an allowance is not made at the service role assignment segment, the RBAC management system escalates the check to the deny assignments segment of the policy (e.g., “deny” rules). This part of the policy blocks requests that match its criteria, thereby acting as a robust barrier against unauthorized activities that could compromise security protocols.

If a request circumvents both the approval of service role assignments and the restrictions of deny assignments segments, the RBAC management system checks the request against the non-service role assignments segment. This part of the policy encompasses the standard access protocols for users or entities, granting permission based on a set of predefined conditions. The RBAC management system then allows or denies a request based on the rules and expressions of these policy segments.

As illustrated in the foregoing discussion, this disclosure utilizes a variety of terms to describe the features and advantages of one or more implementations described. To illustrate, this disclosure describes the policy validation system in the context of a cloud computing system.

For example, the term “Role-Based Access Control (RBAC)” refers to an access control approach that assigns permissions to end-users based on their role within (or outside) a cloud computing system. RBAC provides fine-grained control, offering a simple, manageable approach to access management. For example, RBAC allows administrators to quickly implement changes across all operating systems, applications, and platforms, reducing the potential for error. RBAC also blocks visitors from accessing restricted resources and services of the cloud computing system.

In addition, the term “RBAC policy” refers to policies that enable RBAC. An RBAC policy typically includes roles (e.g., a collection of permissions that are assigned to a user or group of users based on their job function or responsibilities within an organization), permissions (e.g., specific actions or operations that users can perform within a system or application), users (e.g., individuals who are assigned roles and permissions within the RBAC policy), role assignment (e.g., a user can exercise a policy only if the user has selected or been assigned a role), role authorization (e.g., a user's active role must be authorized), and/or permission authorization (e.g., a user can only exercise a policy which is authorized for the user's active role). In some instances, RBAC policies include public or private role definitions. If an RBAC policy is incorrectly defined, it can lead to employees, visitors, or unauthorized users having access to information they should not have, which can result in data breaches and other security incidents.

An RBAC policy includes definitions and properties. A role definition in RBAC is a collection of permissions that specifies what actions users with that role can perform. In various implementations, a role definition includes one or more of the following properties:
Name: The display name of the role.
Id: A unique identifier for the role.
IsCustom: Indicates whether it's a custom role (set to true) or a built-in role (set to false).
Description: A brief description of the role.
Actions: An array of strings specifying control plane actions allowed by the role.
NotActions: An array of strings specifying control plane actions excluded from the allowed actions.
DataActions: An array of strings specifying data plane actions allowed by the role.
NotDataActions: An array of strings specifying data plane actions excluded from the allowed actions.
AssignableScopes: Scopes where the role can be assigned.

In implementations, an RBAC policy includes actions and notActions. Actions and notActions can correspond to control plane actions or data plane actions allowed (or not allowed) by a role. For instance, “actions” represent control plane actions that the role allows to be performed (e.g., read, write, and delete operations). “NotActions” represents control plane actions that are excluded from the allowed actions. In many instances, if an action is listed in NotActions, it's explicitly disallowed. “DataActions” represent specific data plane actions allowed by the role (related to underlying data within an object) and “NotDataActions” represent specific data plane actions that are excluded from the allowed set. While this document describes features referencing actions and notactions, similar principles apply to dataactions and notdataactions.

Additionally, actions and notActions may be formatted in a string that follows the format: {Company}.{ProviderName}/{resourceType}/{action}. In this format, [Company} represents the company or organization, {ProviderName} specifies the service provider (e.g., Company.Compute, Company.Storage), {resourceType} indicates the type of resource (e.g., virtual machines, storage accounts), and {action} describes the type of action (e.g., read, write, custom actions).

In some implementations, an RBAC policy includes Attribute-Based Access Control (ABAC) conditions. These may include additional attributes that add role assignment conditions to an RBAC policy. ABAC allows for policies to include fine-grained access control, where access to specific permissions is granted based on attribute values. For example, with ABAC implemented, a policy management system allows a user access to a specific file only if their security clearance level matches or exceeds the sensitivity level of the file and the file's creation date is within the last 30 days.

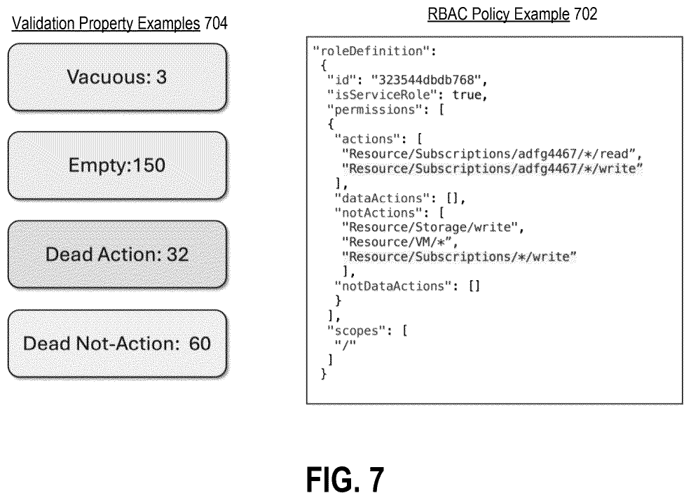

The term “validation property” refers to a set of attributes, protocols, specifications, constraints, and/or characteristics to which RBAC policies should adhere in order to be classified as valid. In various implementations, a validation property is used to verify the validity of an RBAC policy, ensuring that the policy follows the intended semantics and/or assesses whether a policy meets the intended specifications for all possible inputs. Often, a validation property is used to determine the validity of an RBAC policy by checking if no counterexample satisfies the policy while violating the security and authorization intent behind it. Some examples of validation properties include: interns should not be given access to GPUs, external access to internal resources should be prohibited, only full-time employees should have access to GPUs, and new engineers should not have write access to the database. In various implementations, validation policies are based on a set of default properties. In some implementations, the policy management system allows administrators to provide custom properties. Additional examples of validation policies are provided below in FIG. 7.

The term “RBAC policy counterexample” (or “counterexample” for short) refers to an example that contradicts or disproves the generalization that an RBAC policy is valid. For example, a policy has a counterexample when there are user requirement inputs that satisfy the policy but violate the policy's intent (e.g., user requirement inputs that allow unauthorized access to resources in a cloud computing system). The term “counterexample expression” refers to an expression of an RBAC policy that violates the validation property. An example of a counterexample expression is: Validation Property A does not equal Satisfied Policy.

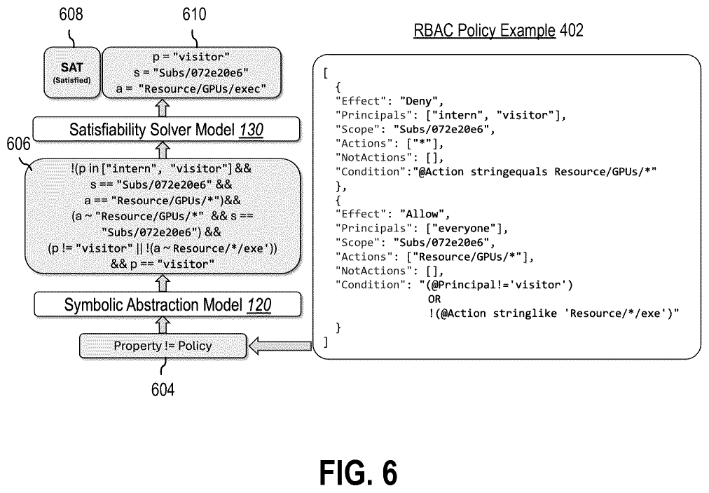

The term “symbolic expression” refers to an expression written at a high level that uses symbolic variables representing multiple possible actual values. Symbolic expressions include non-concrete variables and/or inputs. In many implementations, a symbolic abstraction model generates a symbolic expression using a high-level constraint-solving language. For example, symbolic expressions model sets to a finite extent, samples, or expressions, eliminating the need to represent sets of indefinite length. The term “symbolic counterexample expression” refers to a symbolic expression of a counterexample. An example of a symbolic counterexample expression is provided in FIG. 6.

The term “satisfiability modulo theory” (SMT) refers to a computer-based problem that uses mathematical logic to determine whether a mathematical formula is satisfiable or solvable. In some instances, SMT generalizes the Boolean satisfiability problem (SAT) to more complex formulas involving real numbers, integers, and/or various data structures such as lists, arrays, bit vectors, and strings. In some implementations, the mathematical formula is represented as a satisfiability function representation.

In this disclosure, a “satisfiability function representation” refers to a function that maps a formula's inputs to a Boolean value to determine whether the formula is satisfiable. In various implementations, an SMT solver (e.g., a satisfiability solver model) solves a satisfiability function representation.

Additional definitions may be provided below in this disclosure document.

### The Policy Validation System

As mentioned, this disclosure describes a policy validation system that determines the validity of RBAC policies. For example, the policy validation system determines when invalid RBAC policies implemented within a cloud computing system are granting resource and service requests that should be unauthorized. This way, the policy validation system ensures that RBAC policies adhere to a set of intended specifications across all conceivable inputs in user requests. In various implementations, the policy validation system utilizes symbolic abstraction models and satisfiability solver models to identify invalid policies based on determining valid counterexamples, which allow requests to be granted that should be blocked by the policy.

In particular, the policy validation system provides benefits and solves problems in the art with systems, computer-readable media, and computer-implemented methods by using counter-symbolic expressions and counterexamples along with various models to improve RBAC policy management through validating RBAC policies. As described below, the policy validation system identifies invalid RBAC policies by leveraging a symbolic abstraction model to identify symbolic counterexample expressions of a policy and a satisfiability solver model to determine user requirement inputs that satisfy the counterexamples. Identifying and processing invalid RBAC policies provides numerous technical benefits, as described next.

To illustrate, in one or more implementations, the policy validation system validates role-based access control (RBAC) policies by identifying an RBAC policy and a corresponding validation property to validate against. In response, the policy validation system generates a symbolic counterexample expression of the RBAC policy that violates the validation property using a symbolic abstraction model. In addition, the policy validation system converts the symbolic counterexample expression into a satisfiability function representation to be solved by a satisfiability solver model. Based on receiving a counterexample from the satisfiability solver model, determine that the RBAC policy is invalid for the validation property.

As mentioned above, RBAC allows for the efficient management of different resources within a cloud computing system. However, the process of formulating precise RBAC policies—including defining and assigning roles—is intricate, with inaccuracies potentially leading to unauthorized access and consequential security threats. Furthermore, many RBAC policies are crafted manually by enterprise clients to dictate permissible interactions with cloud resources. However, the intricate nature of these policies, combined with the human error inherent in their manual creation, heightens the risk of security vulnerabilities.

Unfortunately, existing systems do not currently offer tools and processes specifically for this purpose. While some existing systems employ RBAC management tools, these tools require significant computing processing to implement along with demanding significant user expertise. To elaborate, existing systems that provide policy verification methods have not adequately addressed the unique challenges presented by RBAC policies. In particular, RBAC policies often include complexities arising from rich grammatical structures in policy conditions and multi-valued user attributes. Furthermore, cloud computing systems often implement RBAC policies on an extensive scale, which includes detailing hundreds of permitted and non-permitted actions. In some instances, a cloud computing system fields billions of RBAC access check queries hourly. However, existing systems encounter scalability limitations, particularly because RBAC policies are often quite extensive, which necessitate a more robust solution for policy verification.

More particularly, invalid RBAC policies cause various efficiency and accuracy problems. For example, some invalid RBAC policies create vulnerabilities granting unintended or unauthorized access to cloud computing systems. Some invalid RBAC policies block valid access requests. Some invalid RBAC policies include dead actions or non-actions. Each of these examples creates various technical problems for a cloud computing system. Furthermore, errors and bugs in policies, which also cause invalid policies, can have a wide-ranging effect across many resources and services of a cloud computing system, making them even more important to detect.

Accordingly, as described in this disclosure, the policy validation system (and/or other systems of the RBAC management system) delivers several significant technical benefits in terms of improved efficiency, accuracy, and flexibility compared to existing systems. Moreover, the policy validation system provides several practical applications that address problems related to managing and processing RBAC policies in cloud computing systems.

The policy validation system (and/or other systems of the RBAC management system) provides several technical enhancements over existing systems, particularly in versatility, efficiency, and complexity handling. To elaborate, in various implementations, the policy validation system improves efficiency by using a symbolic abstraction model to generate policies into high-level symbolic expressions (which are computationally inexpensive/easily processable) rather than low-level satisfiability modulo theory (SMT) constraints (which are computationally expensive). After processing policies at a high level and pinpointing specific expressions (e.g., counterexamples or portions of a policy), the policy validation system uses the symbolic abstraction model to convert those expressions into a low-level satisfiability function representation for a satisfiability solver model to process. Using the symbolic abstraction model not only simplifies the policy verification query process but also establishes a reusable RBAC model that the policy consistency system may use for model-based testing.

As mentioned above, RBAC policies often include hundreds of Actions and Non-Actions, which challenge the capacity of existing systems. The policy validation system (and/or other systems of the RBAC management system) counters this issue with advanced optimizations and allows for efficient scaling, even with extensive RBAC policies. Again, this is achieved through selectively utilizing the symbolic abstraction model and satisfiability solver model to process policies or portions of policies on a symbolic level.

In various implementations, the policy validation system (and/or other systems of the RBAC management system) provides improved accuracy and flexibility by processing policies at a symbolic level. To illustrate, existing systems often fall short in processing intricate and often advanced operators like “ForAnyOfAll,” which require set comparisons, or managing multi-valued user attributes. The policy validation system (and/or other systems of the RBAC management system) uses a theorem formulation, which demonstrates that modeling an unknown size set can be accomplished with a maximum fixed length by inspecting the policy definition, effectively handling complex operators and multiple user attributes. Moreover, while existing systems usually include straightforward conditions combined with AND, the policy validation system (and/or other systems of the RBAC management system) can recursively utilize AND, OR, NOT, adding a layer of complexity. Indeed, the policy validation system (and/or other systems of the RBAC management system) smoothly handles these recursive Boolean operations, providing a more comprehensive application.

Implementation examples and details of the policy validation system are discussed in connection with the accompanying figures, which are described next. For example, FIG. 2 illustrates an example overview of the policy validation system determining the validity of RBAC policies. FIG. 2 includes a series of acts 200 performed by or with the policy validation system 110 to determine whether an RBAC policy is valid.

As shown, the series of acts 200 includes act 202 of identifying an RBAC policy and a validation property. For example, a set of RBAC policies is being implemented on a cloud computing system, and the policy validation system 110 identifies an RBAC policy 212 from the set to validate. In addition, the policy validation system 110 may identify a validation property 214 from a set of one or more properties for policies to be validated against. In various implementations, the validation property ensures that a policy meets a set of intended constraints or specifications across all possible request inputs. An example of an RBAC policy is provided in FIG. 4, and examples of validation policies are provided in FIG. 7.

Act 204 includes generating a symbolic counterexample expression of the RBAC policy that violates or denies the validation property but is allowed by the policy. For example, the policy validation system 110 provides the RBAC policy 212 and the validation property 214 to a symbolic abstraction model 120, which generates a symbolic counterexample expression 216. In various implementations, the symbolic counterexample expression 216 represents values of the RBAC policy 212 as abstract variables.

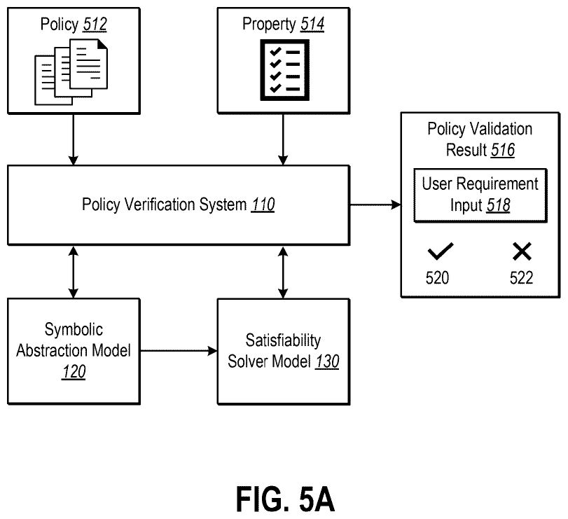

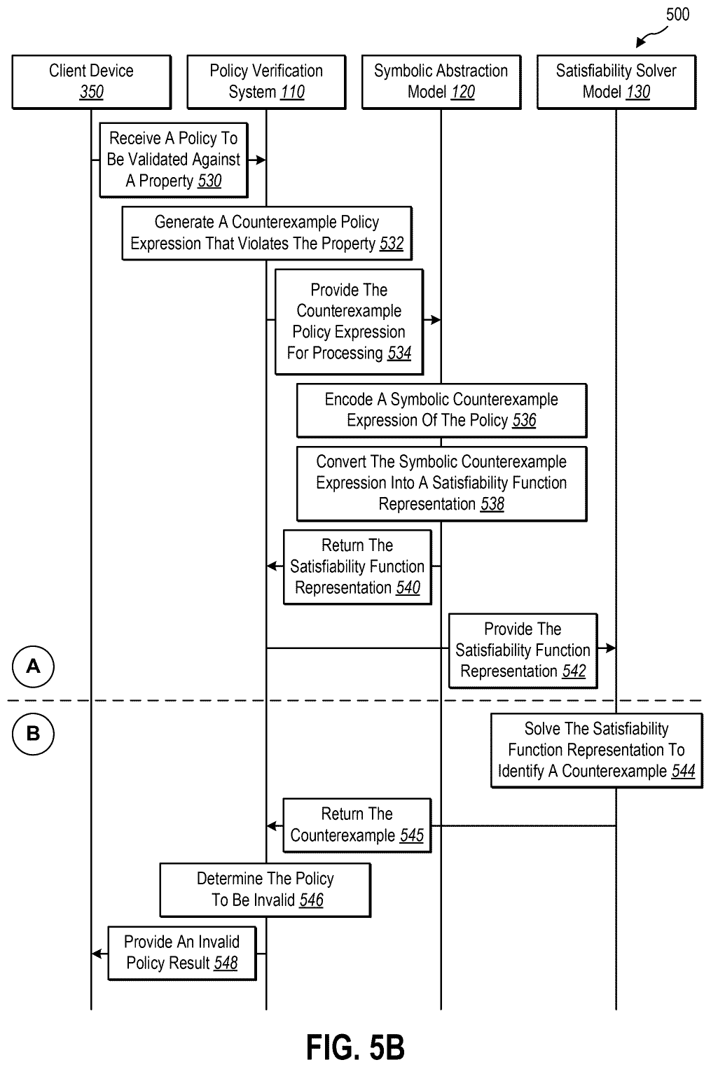

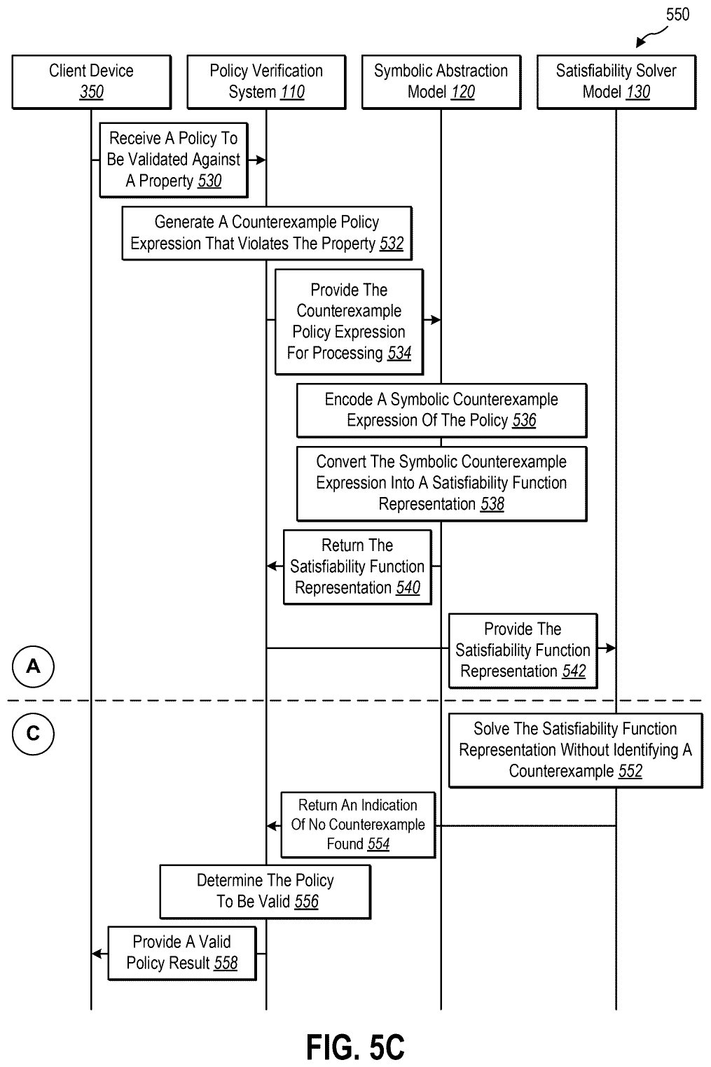

In some implementations, the policy validation system 110 generates a counterexample expression of the RBAC policy 212 that violates the validation property 214, which is provided to the symbolic abstraction model 120. In some instances, the symbolic abstraction model 120 generates expressions in a common intermediate language that provides high-level symbolic descriptions of expressions, which can be easily encoded into different programming languages. Additional details regarding counterexample expressions, the symbolic abstraction models, and the generation of symbolic counterexample expressions are provided below in connection with FIGS. 5A, 5B, and 6.

Act 206 includes converting the symbolic counterexample expression into a satisfiability function representation. In one or more implementations, the policy validation system 110 utilizes the symbolic abstraction model 120 to convert the symbolic counterexample expression 216 into a satisfiability function representation 218 that can be solved by an SMT solver (e.g., a satisfiability solver model). For example, the symbolic abstraction model 120 encodes the symbolic expression into low-level SMT constraints. Additional details regarding the generation of satisfiability function representations are provided below in connection with FIGS. 5A, 5B, and 6.

Act 208 includes providing the satisfiability function representation to a satisfiability solver model to identify whether a counterexample exists. In various implementations, the policy validation system 110 provides the satisfiability function representation 218 to a satisfiability solver model 130 to solve the representation for a solution. If the satisfiability solver model 130 identifies a solution that satisfies the representation (and by extension the symbolic counterexample expression), it outputs a counterexample 220. Otherwise, it outputs no counterexample 222. When providing a counterexample 220, the satisfiability solver model 130 provides a set of user requirement inputs that were used to successfully solve the satisfiability function representation 218. Additional details regarding generating a counterexample are provided below in connection with FIGS. 5A, 5B, and 6. Details regarding generating a non-counterexample are provided below in connection with FIG. 5C.

Act 210 includes determining that the RBAC policy is invalid based on receiving a counterexample. For example, if the policy validation system 110 receives a counterexample 220 from the satisfiability solver model 130, the counterexample 220 can determine that the RBAC policy 212 is invalid (i.e., an invalid RBAC policy 224). Otherwise, if no counterexample 222 is provided, the policy validation system 110 can determine that the RBAC policy 212 is valid (i.e., a valid RBAC policy 226). Additional details regarding determining whether an RBAC policy is valid based on counterexamples and lack of counterexamples are provided below in connection with FIGS. 5A, 5B, and 5C.

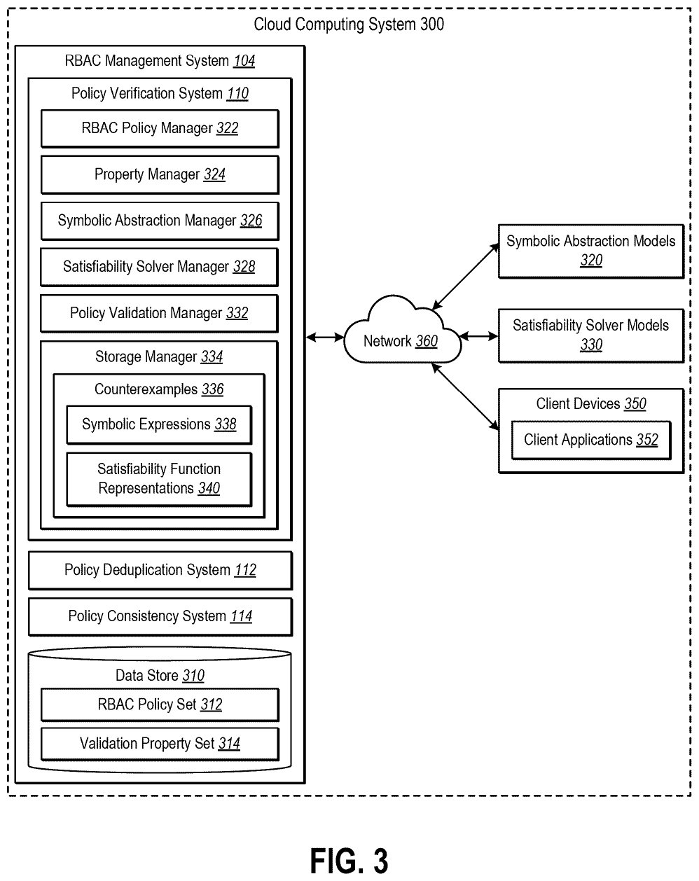

With a general overview in place, additional details are provided regarding the components, features, and elements of the policy validation system. To illustrate, FIG. 3 shows an example computing environment where the policy validation system is implemented according to some implementations. In particular, FIG. 3 illustrates an example of a cloud computing system 300 with various computing devices that are associated with an RBAC management system 104 and/or a policy validation system 110. While FIG. 3 shows example arrangements and configurations of the cloud computing system 300, the RBAC management system 104, the policy validation system 110, and associated components, other arrangements and configurations are possible. Furthermore, the illustrated components may include additional elements not shown.

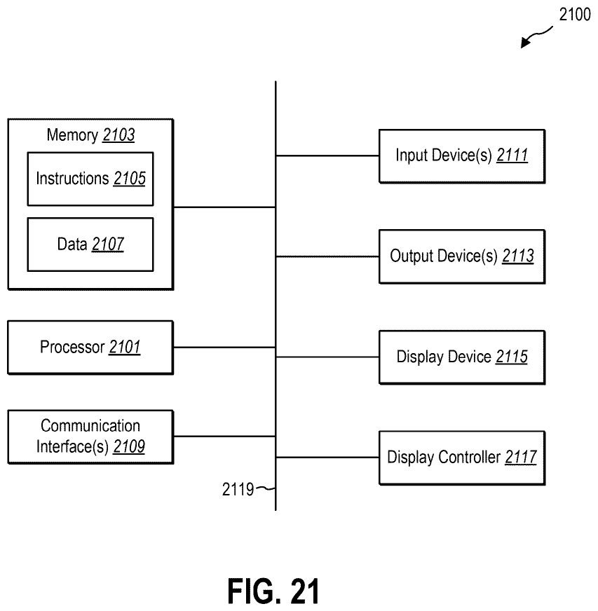

As shown, the cloud computing system 300 includes the RBAC management system 104 having the policy validation system 110, symbolic abstraction models 320, satisfiability solver models 330, and a client device 350 connected via a network 360. These components may be implemented on one or more computing devices, such as one or more server devices. For example, the RBAC management system 104 is implemented across various server devices. Further details regarding computing devices are provided below in connection with FIG. 21, along with additional details regarding networks, such as the network 360 shown.

The RBAC management system 104 is introduced above. In some implementations, the RBAC management system 104 includes features and functionality to process requests and queries submitted by a user associated with the client device 350. For example, the RBAC management system 104 oversees the general processing of requests that invoke RBAC policies from an RBAC policy set 302 within a data store 310 to determine whether access should be granted to a requested cloud service or resource. The RBAC management system 104 may also store a validation property set 314 that provides security guidelines and frameworks for the RBAC policy set 312. In various implementations, a validation policy provides intended specifications or intended constraints for policies.

As introduced above, the RBAC management system 104 provides a foundational framework that may include various systems to improve the efficiency and accuracy of managing policies in the RBAC policy set 312. As shown, the RBAC management system 104 includes the policy validation system 110, the policy deduplication system 112, and the policy consistency system 114. The RBAC management system 104 is described here and the other systems are further described below.

In some implementations, the policy validation system 110 is located on a separate computing device from the RBAC management system 104 within the cloud computing system 300. In various implementations, the policy validation system 110 operates without the RBAC management system 104 or without a cloud computing system 300.

As mentioned earlier, the policy validation system 110 determines which RBAC policies in the RBAC policy set 312 are invalid. As illustrated, the policy validation system 110 includes various components and elements that are implemented in hardware and/or software. For example, the policy validation system 110 includes an RBAC policy manager 322, a property manager 324, a symbolic abstraction manager 326, a satisfiability solver manager 328, a policy validation manager 332, and a storage manager 334. The storage manager 334 includes counterexamples 336 that include symbolic expressions 338 and satisfiability function representations 340.

As mentioned above, the policy validation system 110 includes the RBAC policy manager 322, which manages RBAC policies from the data store 310 for the policy validation system 110 to validate. In some implementations, the RBAC policy manager 322 indicates when a policy is invalid (or valid) and/or indicates why a policy is invalid. In some instances, the RBAC policy manager 322 removes invalid policies from the data store 310.

The policy validation system 110 also includes the property manager 324, which manages properties from the validation property set 314. For example, the property manager 324 obtains a validation property for the policy validation system 110 to test, evaluate, or verify against a policy.

The symbolic abstraction manager 326 on the policy validation system 110 (and/or implemented on another system) manages communications with the symbolic abstraction models 320. For instance, the symbolic abstraction manager 326 provides expressions, including counterexample expressions, of a policy to a symbolic abstraction model. For example, the symbolic abstraction manager 326 instructs a symbolic abstraction model to generate symbolic expressions 338 for counterexamples 336 it provides. The symbolic abstraction manager 326 may use a symbolic abstraction model application programming interface (API) to communicate with the symbolic abstraction models 320.

The satisfiability solver manager 328, located on the policy validation system 110 (or implemented on another system), manages communication with the satisfiability solver models 330. For instance, the satisfiability solver manager 328 generates (or causes to be generated) satisfiability function representations 340 of policies. The satisfiability solver manager 328 may collaborate with the symbolic abstraction manager 326 to generate satisfiability function representations 340 from symbolic expressions 338. The satisfiability solver manager 328 provides, directly or indirectly, the satisfiability function representations 340 to the satisfiability solver models 330 to determine valid input solutions, if available.

The policy validation system 110 includes the policy validation manager 332, which facilitates the validation of policies from the RBAC policy set 312. For example, the policy validation manager 332 pairs policies with properties and generates counterexample expressions used to determine validity. In various implementations, the policy validation manager 332 determines whether a policy is valid based on solutions provided by the satisfiability solver models 330. The policy validation manager 332 may also determine the frequency of validating RBAC policies, the validation properties to be used during policy validation, and/or the actions to be taken for invalid policies.

As shown, the cloud computing system 300 includes the symbolic abstraction models 320 and the satisfiability solver models 330. In some implementations, these models are located on the same devices as the RBAC management system 104. In other implementations, these models are located outside of the cloud computing system 300. The symbolic abstraction models 320 may include compositional network modeling that generates symbolic expressions by encoding the semantics of multiple source languages into a common intermediate language (e.g., Zen). In some cases, a symbolic abstraction model is referred to as a Zen RBAC model. In certain implementations, the symbolic abstraction models 320 utilize mathematical logic to evaluate each policy and generate symbolic expressions that cover a range of potential inputs.

In various implementations, the satisfiability solver models 330 use Boolean, arithmetic, bit-vectors, arrays, or uninterpreted functions to solve the satisfiability function representation. The satisfiability solver models 330 may include SMT solvers, such as Z3, that efficiently determine solutions to satisfiability functions. In some implementations, the satisfiability solver models 330 use a complete, backtracking-based search algorithm or similar algorithms to figure out how to efficiently solve the constraint (e.g., a satisfiability function). In various implementations, the satisfiability solver models 330 use conflict-driven clause learning to guess and check values to see if there are conflicts, which they learn from for the next round of guesses.

As shown, the cloud computing system 300 includes the client device 350. In various implementations, a client device is associated with a user (e.g., a user client device), such as an administrator who maintains the cloud computing system 300, including managing the health of the RBAC policy set 302. In various instances, the client device 350 includes a client application 352, such as a web browser, mobile application, or another form of computer application for accessing and/or interacting with the RBAC management system 104 and/or the policy validation system 110.

As mentioned above, FIG. 4 includes an example of a user request that bypasses the intent of an RBAC policy. In particular, FIG. 4 illustrates an example diagram of a user gaining unauthorized access due to an invalid policy according to some implementations. As shown, FIG. 4 includes an RBAC policy example 402 and a user requirement input example 404.

As shown, in FIG. 4, the user requirement input example 404 includes various input fields and values that characterize the user requesting access, including a Principal field, a Scope field, and an Action field. A user requirement input may include additional or different input fields along with their corresponding values. The user (e.g., the visitor) provides the user requirement input to the cloud computing system to request access to execute the GPUs.

The RBAC policy example 402 includes multiple definitions including a deny assignment (i.e., “Deny”) and a non-service role assignment (i.e., “Allow”), both designed to restrict “exec” permissions for interns and visitors on the GPUs of the cloud computing system. However, a flaw or bug in the policy inadvertently allows a visitor's request to be approved. To elaborate, consider the policy evaluation process the RBAC management system 104 employs when the user requirement input example 404 is received at the cloud computing system.

First, the RBAC management system 104 performs the deny block check. Here, while the Principal and Scope fields align with the request, the RBAC management system 104 detects a mismatch in the Condition of the policy due to an erroneous operator. In particular, the “stringequals” requires an exact match, which causes the “*” to be literally interpreted rather than interpreted as a wildcard (replacing “stringequals” with “stringlike” would solve this mistake). This mistake prevents the deny condition from being triggered or activated, which would deny the request. Rather, the RBAC management system 104 determines that the deny block check is not denied 406.

Second, the RBAC management system 104 performs the allow block check. While the condition of the principal not being a visitor is false, the “OR” operator allows visitors to be granted access under other conditions. In particular, the alternative condition allows visitors to request non-executable actions. However, a typographical error using “exe” rather than the correct “exec” in the alternative condition mistakenly allows visitors to request executable actions, making the alternative condition true as well as the overall condition true. Accordingly, the RBAC management system 104 determines the block check to be allowed 408.

Furthermore, with the deny block check being not denied 406 and the allow block check being allowed 408, the RBAC management system 104 determines that the request, based on the user requirement inputs, is allowed 410 even though allowing the request violates the intent of the RBAC policy.

These oversights underscore the necessity for rigorous policy checking to identify and rectify deviations from the intended security protocols. Moreover, as policy complexity escalates, particularly with extensive ‘actions’ and ‘notActions’ blocks, verification becomes computationally demanding. Accordingly, optimization actions become essential to enhance scalability and maintain the efficacy of these security checks. As noted above, the policy validation system 110 assists the RBAC management system 104 in performing optimizations by catching invalid policies that allow requests against the policy's intent.

Turning to the next set of figures, additional information is provided regarding the implementation of the policy validation system 110 to determine valid and invalid policies. For example, FIGS. 5A-5C illustrate example diagrams for using the policy validation system to determine invalid policies according to some implementations. In particular, FIG. 5A includes components and elements involved in validating an RBAC policy. FIGS. 5B-5C show sequence diagrams for determining an invalid RBAC policy and a valid RBAC policy, respectively.

FIG. 5A includes the policy validation system 110, the symbolic abstraction model 120, and the satisfiability solver model 130, each introduced above. For example, the symbolic abstraction model 120 is a model from the symbolic abstraction models 320, and the satisfiability solver model 130 is a model from the satisfiability solver models 330. FIG. 5A also includes a policy 512 (e.g., an RBAC policy) and a property 514 (e.g., a validation property). In some instances, additional policies and/or properties may be represented and used.

As also shown, the policy validation system 110 generates a policy validation result 516 from the policy 512 and the property 514 using the symbolic abstraction model 120 and the satisfiability solver model 130. The policy validation result 516 may indicate a valid policy 520 or an invalid policy 522. When the policy 512 is invalid, the policy validation result 516 may also include a user requirement input 518 (as shown) that includes input information that proves the policy 512 allows a request while violating or denying the property 514, which should not occur.

With the components and elements in place, FIGS. 5A-5B provide additional detail on how the components interact to determine the policy validation result 516. As shown, FIGS. 5B-5C include communication between the policy validation system 110, the symbolic abstraction model 120, the satisfiability solver model 130, and a client device 350. The client device 350 is provided for additional context.

FIG. 5B includes a series of acts 500 performed by (or for) the policy validation system 110. As shown, the series of acts 500 includes act 530 of the policy validation system 110 receiving a policy to be validated against a property from the client device 350. For example, an administrator provides a request, or sets up a recurring script, for the policy validation system 110 to validate one or more RBAC policies against one or more validation properties. The policy validation system 110 may initiate the process of validating a policy against one or more properties based on a number of circumstances.

Act 532 includes the policy validation system 110 generating a counterexample policy expression that violates the property. In various implementations, the policy validation system 110 generates a counterexample from the policy and the property, where the counterexample occurs when the policy allows a request but the property is denied or violated. In some instances, the policy validation system 110 generates a counterexample policy expression that captures the semantic implications of the counterexample (e.g., an expression that contradicts the policy's intent). For example, the policy validation system 110 generates the counterexample expression of “Property !=Policy.”

Act 534 includes the policy validation system 110 providing the counterexample policy expression to the symbolic abstraction model 120. For example, the policy validation system 110 sends the counterexample policy expression to the symbolic abstraction model 120 with instructions to generate a symbolic version of the expression. The policy validation system 110 may also use the symbolic abstraction model 120 to generate a satisfiability function representation of the expression.

To illustrate, act 536 includes the symbolic abstraction model 120 encoding a symbolic counterexample expression of the policy. In various implementations, encoding or generating a symbolic counterexample expression includes writing the counterexample expression in a common and intermediate language that connects back to multiple source languages. In one or more implementations, the symbolic abstraction model 120 provides enhanced expressive capabilities and adept management of grammatical intricacies to generate a symbolic counterexample expression.

In many implementations, the symbolic abstraction model 120 efficiently handles multi-valued user attributes by symbolically modeling policy rules and sets to a finite extent, inspecting the policy, and eliminating represented sets of indefinite length. In many implementations, using the symbolic abstraction model 120 streamlines the verification process, ensuring thoroughness while accommodating the elaborate constructs inherent in RBAC policies.

Act 538 includes the symbolic abstraction model 120 converting the symbolic counterexample expression into a satisfiability function representation. In various implementations, the symbolic abstraction model 120 generates a satisfiability function representation from the symbolic counterexample expression by converting the symbolic counterexample expression from a high-level common language expression to a low-level SMT model-specific function (e.g., a format compatible with SMT solvers).

Act 540 includes the symbolic abstraction model 120 returning the satisfiability function representation to the policy validation system 110. Act 542 includes the policy validation system 110 providing the satisfiability function representation to the satisfiability solver model 130. In some implementations, the symbolic abstraction model 120 provides the satisfiability function representation directly to the satisfiability solver model 130, as directed by the policy validation system 110.

In FIG. 5B, act 544 includes the satisfiability solver model 130 solving the satisfiability function representation to identify a counterexample. In various implementations, the satisfiability solver model 130 is an SMT solver that evaluates the satisfiability of the expression. A satisfactory result indicates the presence of a counterexample that contradicts the policy's objectives, effectively serving as a violation of the intended constraints. For example, the satisfiability solver model 130 intelligently iterates through different input combinations to determine one or more combinations of inputs that satisfy the provided satisfiability function.

When the satisfiability solver model 130 solves the satisfiability function representation by finding a counterexample, the satisfiability solver model 130 associates the corresponding user requirement inputs with the counterexample. The user requirement inputs provide at least one concrete example of inputs that will be granted by the policy but that go against the validation policy. In some implementations, the satisfiability solver model 130 identifies multiple user requirement inputs and/or a range of user requirement inputs.

Act 545 includes the satisfiability solver model 130 returning the counterexample to the policy validation system 110. For example, the policy validation system 110 receives the counterexample, which also includes the user requirement inputs that trigger the counterexample.

Act 546 includes the policy validation system 110 determining that the policy is invalid. For instance, based on receiving a counterexample and/or user requirement inputs, the policy validation system 110 determines that the RBAC policy is invalid and will allow requests it is intended to block.

Act 548 includes the policy validation system 110 providing the results of the invalid policy to the client device 350 in response to the original request. In some implementations, the policy validation system 110 also provides the counterexample and/or the user requirement input. In various implementations, the policy validation system 110 provides the policy result as part of a report indicating the validity of multiple policies in a set of policies maintained by a cloud computing system.

Additionally, in one or more implementations, the policy validation system 110 determines that the RBAC policy is invalid for the validation property, which indicates that the RBAC policy is vulnerable to allowing adverse actions. In these implementations, the policy validation system may modify the RBAC policy to disallow the counterexample (e.g., based on determining that the RBAC policy is vulnerable to allowing adverse actions). In various implementations, the policy validation system 110 may flag an invalid RBAC policy for review based on determining that the RBAC policy is invalid and vulnerable to allowing adverse actions.

While FIG. 5B illustrates an example of an invalid policy result, FIG. 5C illustrates an example of a valid policy result. FIG. 5C includes a series of acts 550 that includes the initial acts as the series of acts 500 described in connection with FIG. 5B. For example, the series of acts 550 in FIG. 5C includes acts 530-542, as previously described.

In FIG. 5B, the series of acts 550 includes act 552 of the satisfiability solver model 130 solving the satisfiability function representation without identifying a counterexample. As mentioned above, the satisfiability solver model 130 may be an SMT solver that evaluates the satisfiability of the expression. However, in various implementations, the satisfiability solver model 130 does not identify a counterexample that produces a satisfactory result (e.g., it does not determine a counterexample that contravenes the policy's objectives). For example, the satisfiability solver model 130 intelligently iterates through different input combinations but fails to determine a combination of inputs that satisfies the provided satisfiability function. In these implementations, the satisfiability solver model 130 determines the expression (presented in the satisfiability function representation format) to be unsatisfiable.

Act 554 includes the satisfiability solver model 130 returning an indication of no counterexample found to the policy validation system 110. For example, the policy validation system 110 receives a negative counterexample indication from the satisfiability solver model 130.

Act 556 includes the policy validation system 110 determining the policy to be valid. For instance, based on not receiving a counterexample, the policy validation system 110 determines that the RBAC policy correctly upholds the intended specifications conveyed in the validation property. Thus, the policy is valid for all user requirement inputs.

Act 558 includes the policy validation system 110, which provides the validated policy result to the client device 350 in response to the original request. In various implementations, the policy validation system 110 provides the policy result as part of a report indicating the validity of multiple policies in a set of policies maintained by a cloud computing system. Overall, the policy validation system 110 plays a pivotal role in affirming the integrity of a policy or pinpointing specific instances (e.g., user requirement inputs) where the policy fails.

FIG. 6 illustrates an example diagram of the policy validation system detecting that the policy of FIG. 4 is invalid according to some implementations. In particular, FIG. 6 provides another perspective of the policy validation system 110 identifying an invalid policy by determining at least one set of user requirement inputs that violates the intent of the policy and/or bypasses security measures. FIG. 6 utilizes the RBAC policy example 402 described above in connection with FIG. 4.

To elaborate, the policy validation system 110 obtains the RBAC policy example 402 to be validated against one or more properties. As described above, the policy validation system 110 generates a counterexample policy expression 604 indicating a case when the policy allows a request that violates the intent of the request (e.g., the property).

As shown, the policy validation system 110 provides the counterexample policy expression 604 to the symbolic abstraction model 120, which generates a symbolic counterexample expression 606. As shown, the symbolic counterexample expression 606 includes abstract, symbolic variables in a high-level, common language.

The policy validation system 110 provides the symbolic counterexample expression 606 to the satisfiability solver model 130. In various implementations, as described above, the satisfiability solver model 130 first converts the symbolic counterexample expression 606 to an SMT solver-compatible format (e.g., a satisfiability function representation). In some implementations, the satisfiability solver model 130 generates the satisfiability function representation from the symbolic counterexample expression 606.

As shown, the satisfiability solver model 130 processes the satisfiability function representation to determine whether the function yields a satisfied answer 608 that proves the counterexample expression. If satisfied, the satisfiability solver model 130 provides a counterexample 610 with at least one set of user requirement inputs, as shown in FIG. 6. Otherwise, the satisfiability solver model 130 reports that the satisfiability function was not satisfied.

FIG. 7 illustrates an example diagram of the policy validation system determining property violations in a set of RBAC policies according to some implementations. In particular, FIG. 7 includes validation results from a set of around 1,100 RBAC policies tested by the inventors.

FIG. 7 includes validation property examples 704 and an RBAC policy example 702 representing an RBAC policy in the set. The validation property examples 704 include a vacuous property (e.g., all requests are allowed), an empty property (e.g., all requests are denied), a dead-action property (e.g., at least one action in the policy cannot be reached), and a dead non-action property (e.g., at least one non-action in the policy cannot be reached). As shown in the highlighted portions of the RBAC policy example 702, the policy includes a role action with a dead action (e.g., a conflicting action and non-action).

The inventors tested each policy in the set of RBAC policies against the validation property examples 704. The results were as follows:
Vacuous Property Instances: 3 role definitions were found to be vacuous, meaning they are overly permissive, essentially allowing all requests. Such policies fail to enforce meaningful restrictions, potentially exposing the system to unwarranted access.
Empty Property Instances: 150 role definitions include empty policies that deny all requests. These policies, in their current form, serve no practical purpose as they contribute no functional access control specifications.
Dead-Action Instances: 32 roles contained redundant actions that do not alter the access outcome. These dead actions represent policy bloat, complicating policy management without providing added value.
Dead-NotAction Instances: 60 roles harbored redundant NotActions, which, like dead actions, add unnecessary complexity without influencing the policy's behavior.

In this policy validation evaluation, the 245 identified role definitions are indicative of invalid policies that include misconfigurations or oversights. This underscores the need for the policy validation system 110, which enhances RBAC policy efficacy in a cloud computing system.

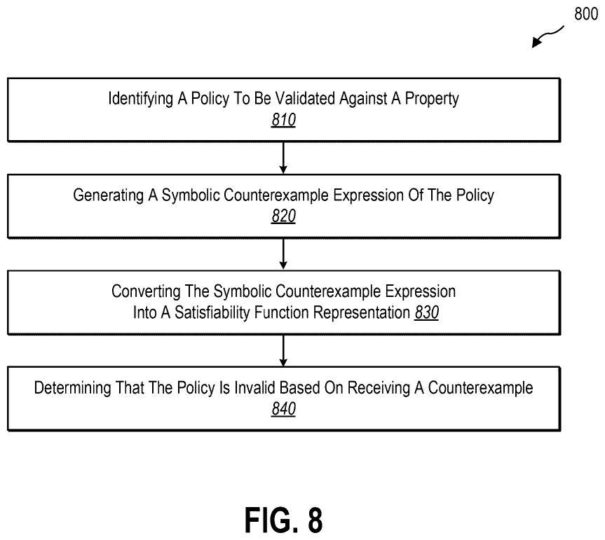

Turning now to FIG. 8, this figure illustrates an example series of acts in a computer-implemented method for validating one or more RBAC policies according to some implementations. While FIG. 8 illustrates acts according to one or more implementations, alternative implementations may omit, add, reorder, and/or modify any of the acts shown. In particular, FIG. 8 includes a series of acts 800 for verifying role-based access control (RBAC) policies.

The acts in FIG. 8 can be performed as part of a method (e.g., a computer-implemented method). Alternatively, a computer-readable medium can include instructions that, when executed by a processing system with a processor, cause a computing device to perform the acts in FIG. 8. In some implementations, a system (e.g., a processing system comprising a processor) can perform the acts in FIG. 8. For example, the system includes a processing system and a computer memory including instructions that, when executed by the processing system, cause the system to perform various actions or steps.

As shown, the series of acts 800 includes act 810 of identifying a policy to be validated against a property. For instance, in example implementations, act 810 involves identifying an RBAC policy and a validation property to validate an intended specification of the RBAC policy. In various implementations, act 810 includes the RBAC policy defining an effect, a principal, an action, and a not-action. In some implementations, the RBAC policy defines a scope and a condition. In some implementations, the effect is to deny or allow a request based on corresponding definitions being satisfied. In one or more implementations, the RBAC policy is part of a set of RBAC policies implemented by a cloud computing system for authorizing access to resources of the cloud computing system.

As further shown, the series of acts 800 includes act 820 of generating a symbolic counterexample expression of the policy. For instance, in example implementations, act 820 involves generating a symbolic counterexample expression of the RBAC policy that violates the validation property using a symbolic abstraction model. In some implementations, the symbolic abstraction model generates the symbolic counterexample expression into a common intermediate language that encodes the semantics of multiple source languages. In various implementations, the multiple source languages include C# and C++. In one or more implementations, the symbolic abstraction model (e.g., Zen) is a constraint-solving model that generates the symbolic counterexample expression by transforming grammatically intricate policy definitions into abstract representations.

As shown, the series of acts 800 includes act 830 of converting the symbolic counterexample expression into a satisfiability function representation. For instance, in some implementations, act 830 involves converting the symbolic counterexample expression into a satisfiability function representation to be solved by a satisfiability solver model. In one or more implementations, the satisfiability solver model is a satisfiability modulo theory (SMT) solver. In some implementations, the satisfiability solver model utilizes Boolean, arithmetic, bit-vectors, arrays, or uninterpreted functions to solve the satisfiability function representation.

As shown, the series of acts 800 includes act 840 of determining that the policy is invalid based on receiving a counterexample. For instance, in some implementations, act 840 involves determining that the RBAC policy is invalid for the validation property based on receiving a counterexample from the satisfiability solver model. In one or more implementations, the counterexample includes a user requirement input that violates the RBAC policy. In some instances, the user requirement input includes a principal value and an action value. In some cases, the user requirement input includes a scope value. In various instances, the user requirement input is provided to a cloud computing system to request access.

In various implementations, act 840 includes determining that the RBAC policy is invalid for the validation property based on determining that the RBAC policy is vulnerable to allowing adverse actions. In some implementations, act 840 includes modifying the RBAC policy to disallow the counterexample based on determining that the RBAC policy is vulnerable to allowing or performing adverse actions. In various implementations, act 840 includes removing the RBAC policy based on determining that the RBAC policy is vulnerable to allowing or performing adverse actions. In one or more implementations, act 840 includes flagging the RBAC policy for review based on determining that the RBAC policy is vulnerable to allowing or performing adverse actions.

In some implementations, the series of acts 800 includes additional acts. For example, the series of acts 800 includes generating a second symbolic counterexample expression of the RBAC policy violating a second validation property using the symbolic abstraction model, converting the second symbolic counterexample expression into a second satisfiability function representation to be solved by the satisfiability solver model, and based on failing to receive any counterexample from the satisfiability solver model, determining that the RBAC policy is valid for the validation property.

### The Policy Deduplication System

As mentioned, this disclosure describes a policy deduplication system that determines duplicates among a set of RBAC policies. For instance, the policy deduplication system determines whether a pair of RBAC policies within a cloud computing system are semantically equivalent, even if they are syntactically distinct. In many implementations, the policy deduplication system utilizes symbolic abstraction models and satisfiability solver models to identify duplicate policies that are semantically equal for all user inputs by searching for counterexamples that would prove a pair of policies to be semantically unequal. However, if no counterexamples are found, the policy deduplication system determines that the policies are duplicates.

In particular, the policy deduplication system provides benefits and solves problems in the art with systems, computer-readable media, and computer-implemented methods by using counter-symbolic expressions and counterexamples along with various models to improve RBAC policy management by identifying and removing duplicate RBAC policies. As described below, the policy deduplication system identifies semantically equivalent RBAC policies by leveraging a symbolic abstraction model to identify symbolic counterexample expressions between policy segments of the policies and a symbolic abstraction model to determine user requirement inputs that satisfy the counterexamples. Identifying, processing, and/or removing duplicate RBAC policies provides numerous technical benefits, as described next.

To illustrate, in one or more implementations, the policy deduplication system determines policy equivalence in RBAC policies by generating policy expressions for a pair of RBAC policies. For instance, the policy deduplication system divides the first policy expression into a first set of multiple segments, including a first segment where the first segment pairs a first action in the first RBAC policy with a first set of notactions in the first RBAC policy. In addition, the policy deduplication system determines that the first action and the first set of notactions of the first segment of the first policy expression are semantically equivalent to the second policy expression of the second RBAC policy by using a symbolic abstraction model that generates symbolic counterexample expressions and a satisfiability solver model that solves for counterexamples. Based on the first segment of the first policy expression being semantically equivalent to the second policy expression, the policy deduplication system determines that the first RBAC policy is a semantic duplication of the second RBAC policy.

Explained at a high level, two policies are considered equal if there are no examples of user inputs where one policy allows an action while the other policy denies it. Therefore, the policy deduplication system searches for a counterexample where one policy allows the action while the other denies it. As explained below, the policy deduplication system intelligently determines whether a counterexample exists by breaking down a policy into segments and comparing each segment to all segments of another policy. These small comparisons can be performed quickly and if a counterexample is found, the policy deduplication system can immediately stop or terminate the process. If no counterexample is found, the two policies are equivalent.

As described in this document, the policy deduplication system (and/or other systems of the RBAC management system) delivers several significant technical benefits in terms of improving the efficiency of policy equivalence checking compared to existing systems. Moreover, the policy deduplication system provides several practical applications that address problems related to managing and processing RBAC policies in cloud computing systems, including determining when a set or pool of RBAC policies includes unnecessary duplicates. While many technical benefits are described above (especially by using a symbolic abstraction model and satisfiability solver model), additional benefits and practical applications of the policy deduplication system are described below.

As mentioned above, RBAC improves the efficient management of RBAC policies within a cloud computing system by optimizing duplicate policy checks within policy pools. To elaborate, many cloud computing systems face constraints on the number of creatable policies, making the process of identifying and removing semantically redundant policies crucial to free up space for new, necessary policies. Indeed, by removing duplicate policies, the policy validation system optimizes the memory space allocated for storing policies. Furthermore, removing redundant policies reduces wasted memory and unnecessary processing power.

To illustrate, in a cloud computing system that includes a pool of N policies, existing systems require O(N²) comparisons to identify duplicate policies. This process is time- and resource-intensive for pools or sets of simple RBAC policies. In many instances, RBAC policies include extensive strings characterizing the actions and notActions, which challenge the methods used by existing systems to compare policies. Furthermore, larger policies that feature hundreds of actions and notActions require significantly more computing resources to process when using the methods of existing systems.

In various implementations, the policy deduplication system circumvents the inefficiencies of existing systems by using a string compression strategy and/or a policy breakdown approach that significantly simplifies policy comparisons. For example, the policy deduplication system uses an equivalence check query to compare a pair of policies. However, rather than directly comparing the two policies, the policy validation system separates the equivalence check query into directional checks (e.g., sub-queries). The policy validation system separately processes each directional check by dividing each policy into segments that are easily compared against the other policy to determine equivalency. This way, the policy validation system significantly streamlines the duplicate identification process without compromising accuracy or thoroughness.

To further elaborate, some existing systems use satisfiability solver models to compare pairs of policies. For example, an existing system provides an equivalence check query for two policies to a satisfiability solver model. For larger policies, the process took around 30 minutes to determine whether the policies were equivalent. In contrast, the policy validation system can determine policy equivalence for the same policies in three seconds or less using the breakdown approach. Depending on other features applied, the policy deduplication system may determine equivalency in less than 0.5 seconds. In special circumstances, the policy deduplication system reduces the verification time for a larger policy to 0.16 seconds, a 10,000-fold increase in efficiency. Indeed, this improvement allows the policy deduplication system to compare policies in real-time, or close to real time (e.g., the policy deduplication system can quickly evaluate a newly added policy to see if it is a duplicate).

In some instances, the policy validation system assigns unique integers to represent distinct keywords to simplify comparisons. For example, the policy validation system allocates lower integer values to more frequently occurring keywords, which optimizes compression effectiveness. This, along with other approaches described in connection with the policy validation system, provides efficiency improvements that are further evident when applied to symbolic abstraction models and satisfiability solver models, as described below.

FIG. 9 illustrates an example overview of the policy deduplication system determining the validity of RBAC policies according to some implementations. FIG. 9 includes a series of acts 900 performed by or with the policy deduplication system 112 to determine whether a pair of RBAC policies are semantically equal. As shown, the series of acts 900 includes act 902 of the policy deduplication system 112 generating an equivalence check query between a pair of policies using policy expressions. For example, the policy deduplication system 112 identifies a first RBAC policy 912 and a second RBAC policy 914 within a set or pool of RBAC policies. The policy deduplication system 112 then generates an equivalence check query 910 (e.g., P1⇔P2) that indicates an equivalence correlation between the policy expressions.

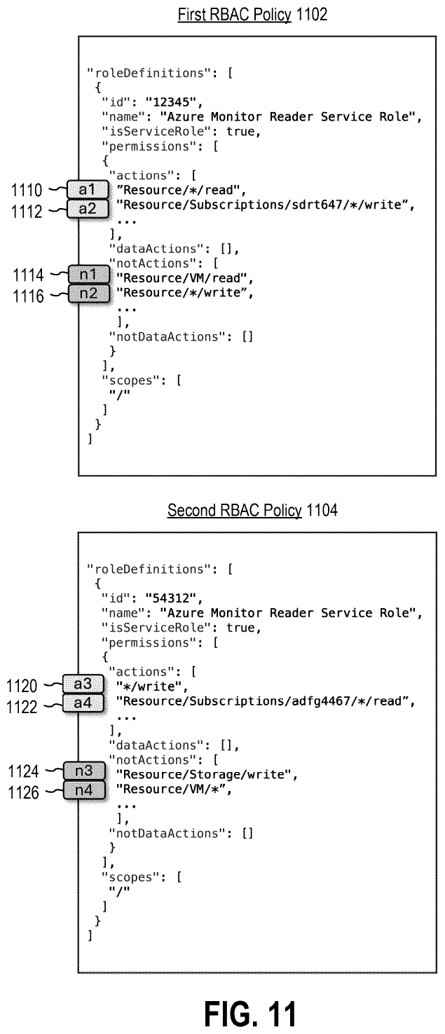

In various implementations, as part of generating the equivalence check query 910, the policy deduplication system 112 first generates policy expressions for the first RBAC policy 912 and the second RBAC policy 914, such as the first policy expression 913 and the second policy expression 915. As shown, the policy expressions include actions and notactions for each policy. Accordingly, the equivalence check query 910 expresses an equivalence between the actions and notactions of the two policies. Additional details regarding policies and equivalence check queries are provided in connection with FIG. 11.

Act 904 includes the policy deduplication system 112 dividing the equivalence check query into two parts and breaking down each policy expression into segments for each of the two parts. In various implementations, the policy deduplication system 112 utilizes a breakdown approach to simplify comparisons between the compared policies and improve comparison times. To illustrate, in one or more implementations, the policy deduplication system 112 separates the equivalence check query 910 into a first directional check 918 and a second directional check 920.

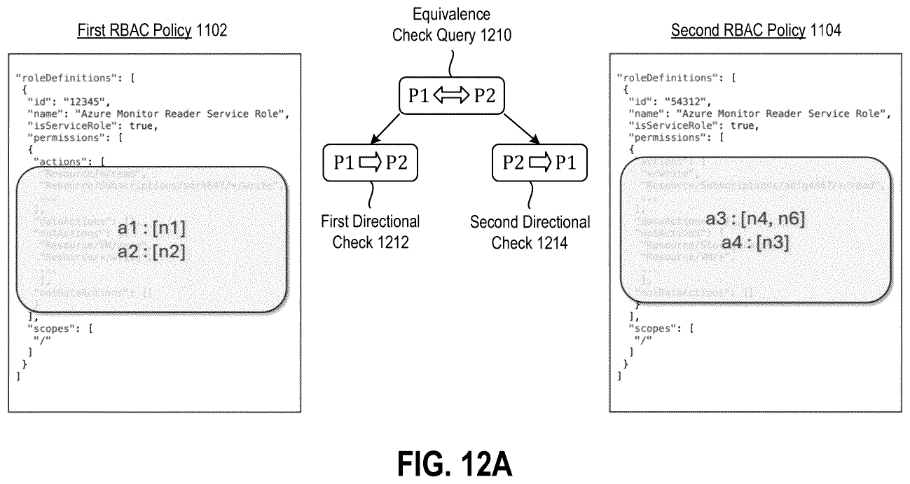

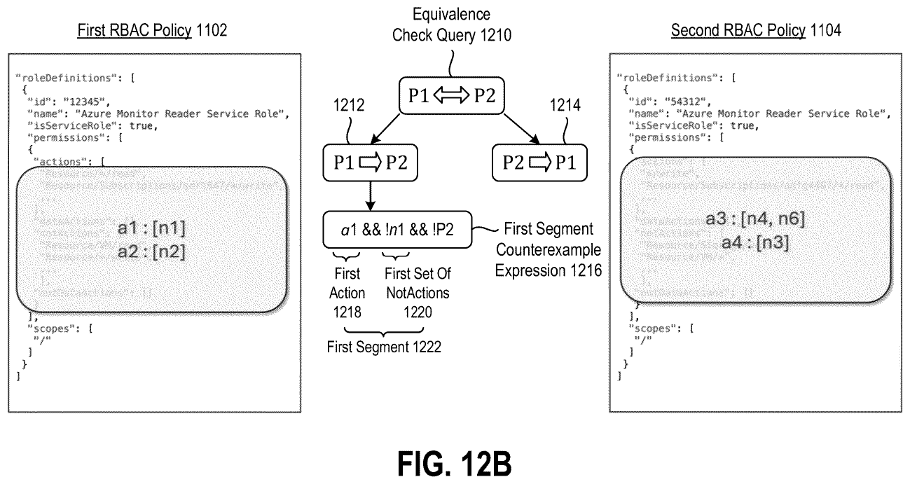

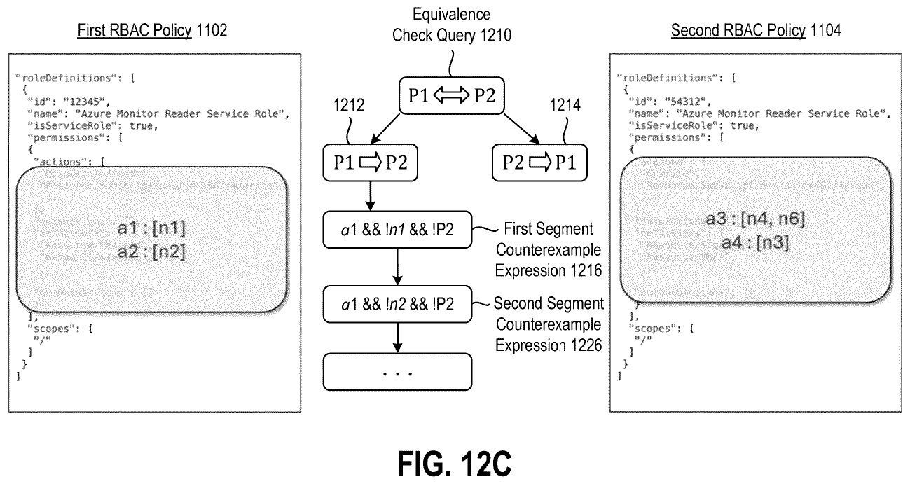

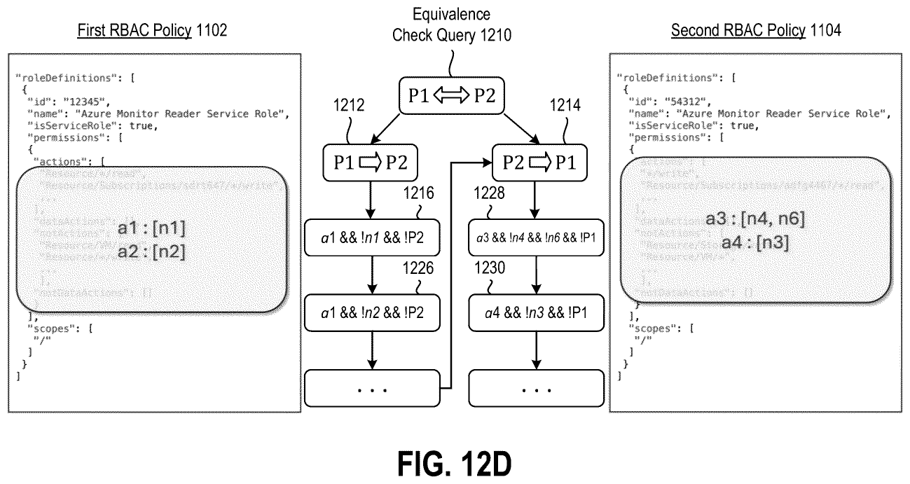

Additionally, for each directional check, the policy deduplication system 112 divides one of the policies (e.g., the first listed policy) into segments. As shown, the policy deduplication system 112 creates a first set of multiple segments 922 from the first directional check 918 and a second set of multiple segments 924 from the second directional check 920. Additional details regarding policies and equivalence check queries are provided in connection with FIGS. 12A-12D.

Act 906 includes the policy deduplication system 112 searching for a counterexample for each broken-down segment (unless a counterexample is found) using a symbolic abstraction model and a satisfiability solver model. For example, for the first segment 932 of the first directional check 918, the policy deduplication system 112 generates a first segment counterexample expression 926 indicating that a first action 928 and none of a first set of notactions 930 of the first RBAC policy 912 conflicts with the second RBAC policy 914 (represented as the second policy expression 915). If a counterexample is found, the policy deduplication system 112 stops checking additional broken-down segments. Additional details regarding segment counterexample expressions are provided in connection with FIGS. 12A-12D.

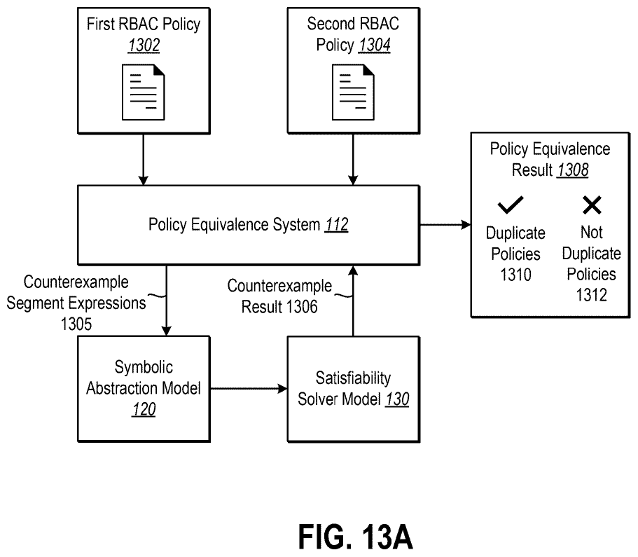

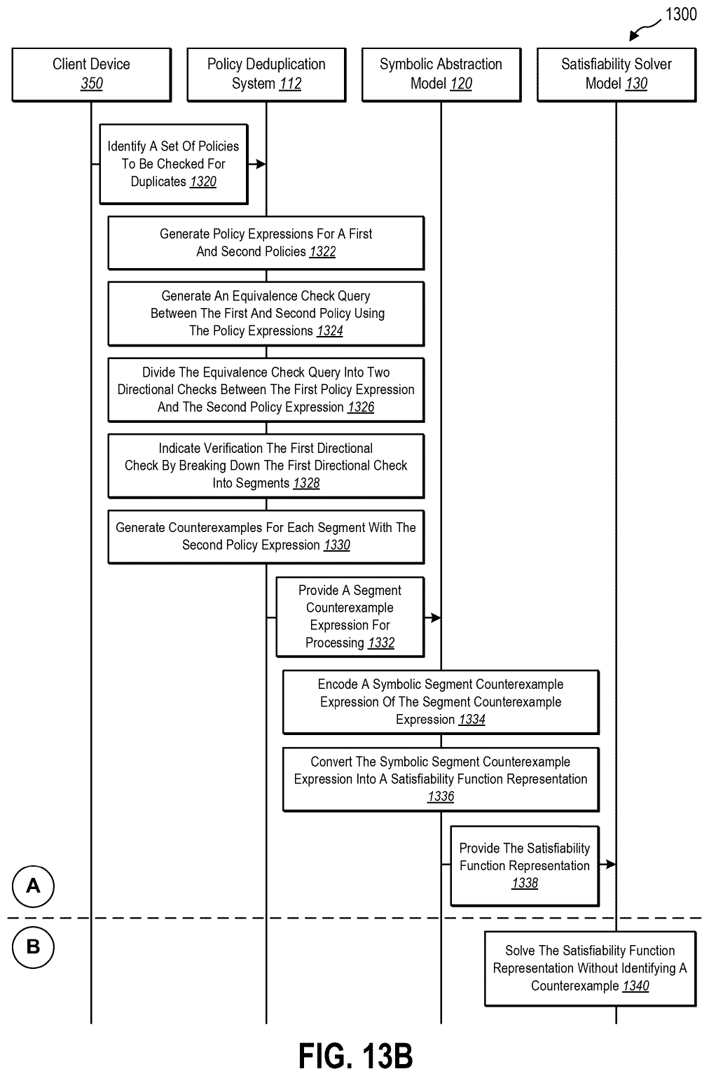

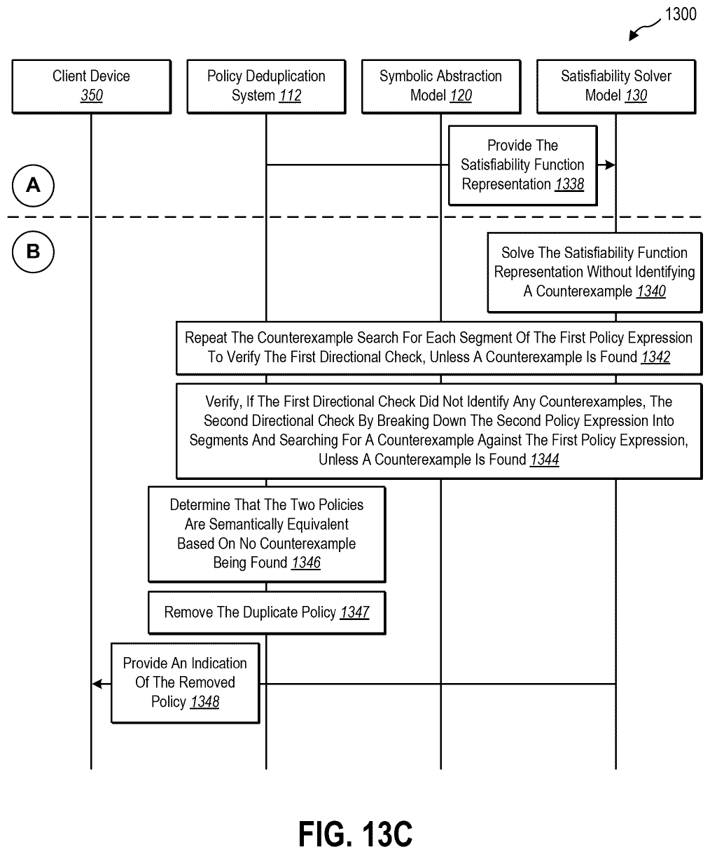

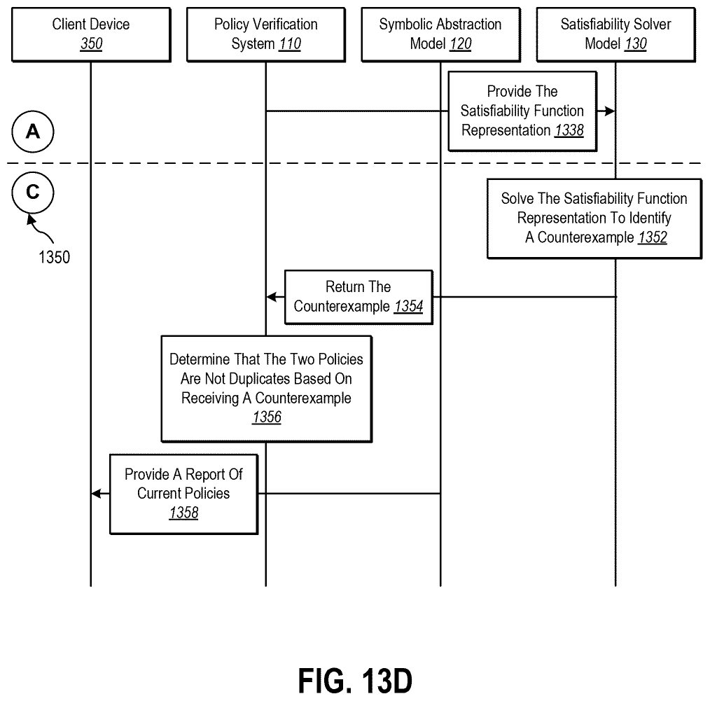

Act 906 also includes the policy deduplication system 112 providing the first segment counterexample expression 926 to the symbolic abstraction model 120 and the satisfiability solver model 130. As further described below, the symbolic abstraction model 120 generates a symbolic counterexample expression and corresponding satisfiability function representation while the satisfiability solver model 130 determines if there is a solution to the satisfiability function representation. Based on solving the satisfiability function representation, the satisfiability solver model 130 provides a counterexample 934 or no counterexample 936. Additional details regarding the symbolic abstraction model and satisfiability solver model are provided in connection with FIGS. 13A-13D.

Act 908 includes the policy deduplication system 112 determining whether the two policies are duplicates based on a counterexample being found. In many implementations, if no counterexample is found for the first segment counterexample expression 926, the policy deduplication system 112 moves on to a second segment counterexample expression and continues through all the segments of the first directional check 918 as long as a counterexample is not found. The policy deduplication system 112 then proceeds to the first directional check 918, repeating the same process. If no counterexample is found, the policy deduplication system 112 determines that the first RBAC policy 912 is semantically equivalent to the second RBAC policy 914 for all user inputs (e.g., user requirement inputs). Otherwise, if a counterexample 934 is found, the policy deduplication system 112 stops all future processing and determines that the two policies are distinct.

In some implementations, if the two policies are semantically equivalent, the policy deduplication system 112 records the policies as duplicates. In various implementations, the policy deduplication system 112 automatically removes one of the duplicate policies. Additional details regarding policy duplication determinations are provided in connection with FIGS. 13A-13D.

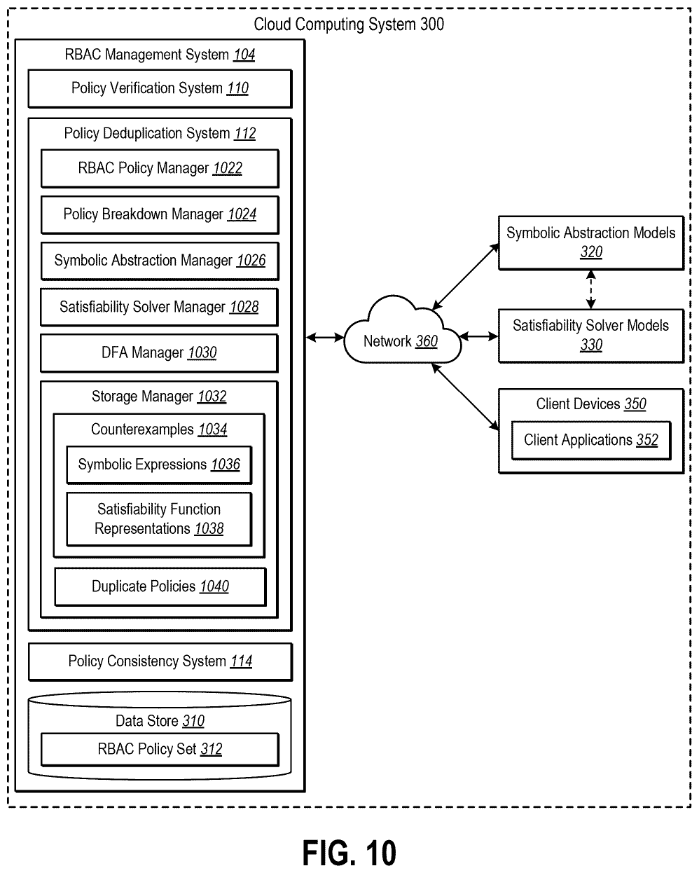

With a general overview in place, additional details are provided regarding the components, features, and elements of the policy deduplication system 112. To illustrate, FIG. 10 shows an example computing environment where the policy deduplication system is implemented according to some implementations. While FIG. 10 shows example arrangements and configurations of the cloud computing system 300, the RBAC management system 104, the policy deduplication system 112, and associated components, other arrangements and configurations are possible. Furthermore, the illustrated components may include additional elements not shown.

In particular, FIG. 10 shows the same cloud computing system provided above in connection with FIG. 3. However, while FIG. 3 described the cloud computing system 300 as a whole and focused on the policy validation system 110, FIG. 10 focuses on the policy deduplication system 112. Thus, FIG. 10 builds upon the descriptions of the components and elements previously described (e.g., the RBAC management system 104, the symbolic abstraction models 320, the models 330, and the client device 350) with an added emphasis on the policy deduplication system 112.

Turning to the policy deduplication system 112 within the RBAC management system 104, the policy deduplication system 112 includes various components and elements that are implemented in hardware and/or software. For example, the policy validation system 110 includes an RBAC policy manager 1022, a policy breakdown manager 1024, a symbolic abstraction manager 1026, a satisfiability solver manager 1028, a DFA manager 1030 (e.g., a deterministic finite automation manager), and a storage manager 1032. The storage manager 1032 includes counterexamples 1034 that include symbolic expressions 1036 and satisfiability function representations 1038. The storage manager 1032 also includes duplicate policies 1040.

Notably, some of the components of the policy deduplication system 112 share the same names as components of the policy validation system 110. For example, both the policy deduplication system 112 and the policy validation system 110 include a symbolic abstraction manager. In some implementations, the correlating components are the same component and provide the functionality described in both sections. In some implementations, the correlating components are different components that perform independent operations. Likewise, in some implementations, the policy deduplication system 112 and the policy validation system 110 are joined into one system and perform some or all of the operations described in this document.

As mentioned, the policy deduplication system 112 includes the RBAC policy manager 1022, which accesses RBAC policies in the RBAC policy set 312 within the data store 310 for the policy deduplication system 112. For example, the RBAC policy manager 1022 facilitates the policy deduplication system 112 in performing policy equivalence or duplication checks on a pool of policies in the RBAC policy set 312. In some implementations, the RBAC policy manager 1022 determines when a pair of policies are semantically equivalent based on receiving counterexamples 1034 and/or automatically removes duplicate policies 1040 from the RBAC policy set 312.

The policy validation system 110 also includes a policy breakdown manager 1024, which separates, splits, divides, reduces, and/or otherwise breaks down policies into smaller portions. For example, the policy breakdown manager 1024 generates existing computer systems and policy expressions for a pair of policies being compared. Additionally, in some implementations, the policy breakdown manager 1024 generates multiple directional checks from an equivalence check query. In various implementations, the policy breakdown manager 1024 also generates a set of multiple segments for a policy in the directional checks.

The symbolic abstraction manager 1026 on the policy validation system 110 (and/or implemented on another system) manages communications with the symbolic abstraction models 320. For instance, the symbolic abstraction manager 1026 provides expressions, including segment counterexample expressions, of a policy to a symbolic abstraction model. For example, the symbolic abstraction manager 1026 instructs a symbolic abstraction model to generate symbolic expressions 1036 for counterexamples 1034 it provides. The symbolic abstraction manager 1026 may use a symbolic abstraction model application programming interface (API) to communicate with the symbolic abstraction models 320.

The satisfiability solver manager 1028, located on the policy deduplication system 112 (or implemented on another system), manages communication with the satisfiability solver models 330. For instance, the satisfiability solver manager 1028 generates (or causes to be generated) satisfiability function representations 1038 of policy segments. The satisfiability solver manager 1028 may collaborate with the symbolic abstraction manager 1026 to generate satisfiability function representations 340 from symbolic expressions 1036 of policy counterexample segments. The satisfiability solver manager 1028 provides, directly or indirectly, the satisfiability function representations 1038 to the satisfiability solver models 330 to determine valid input solutions if available.

The policy deduplication system 112 includes the DFA manager 1030, which uses a DFA algorithm to determine equivalence checks when policies meet certain conditions. For example, the DFA manager 1030 determines whether a pair of policies includes attribute characteristics and based on the determination, whether to apply a breakdown approach or a DFA approach, as further described below.

As shown, the cloud computing system 300 also includes the symbolic abstraction models 320, the models 330, and the client device 350, which are described above in connection with FIG. 3. In some implementations, the client device 350 provides instructions, commands, scripts, and/or programming to implement equivalence checks in the RBAC policy set 312 of the cloud computing system 300.

As mentioned above, FIG. 11 includes examples of RBAC policies that may belong within an RBAC policy pool or set on a cloud computing system. In particular, FIG. 11 illustrates an example of a pair of RBAC policies to be compared for equivalence according to some implementations.

As shown, FIG. 11 includes a first RBAC policy 1102 and a second RBAC policy 1104. Both policies include role definitions with a set of properties. For example, both policies include an identifier, a name, a role, permissions, and scopes. As shown, the permissions include actions and notactions. In particular, the permissions include actions, notactions, dataactions, and notdataactions. As mentioned, policies may include a large number (e.g., hundreds) of permission definitions. While this document describes features referencing actions and notactions, similar principles apply to dataactions and notdataactions.

As shown, each policy can have multiple allowed actions ([a1, a2, . . . ]) and not allowed actions ([n1, n2, . . . ]). For example, the first RBAC policy 1102 includes a first action 1110 with the label “a1” and a second action 1112 with the label “a2.” The first RBAC policy 1102 also includes a first notaction 1114 with the label “n1” and a second notaction 1116 with the label “n2.” In some instances in the figures, the first notaction 1114 uses the label “n1” and the second notaction 1116 uses the label “n2.”

As also shown, the second RBAC policy 1104 includes a third action 1120 with the label “a3” and a fourth action 1122 with the label “a4.” The second RBAC policy 1104 also includes a third notaction 1124 with the label “n3” and a fourth notaction 1126 with the label “n4.” Similarly, in some instances in the figures, the third notaction 1124 uses the label “n3” and the fourth notaction 1126 uses the label “n4.”

As mentioned above, following a crude approach similar to existing systems, the policy deduplication system 112 may check the equivalence between the two policies. For example, the policy deduplication system 112 may transpose the policies directly into a large satisfiability function. As mentioned above, this type of direct conversion, especially for extensive policies, results in considerably large computing expressions that demand substantial computational power and time to ascertain whether equivalence exists. For instance, to ascertain whether the first RBAC policy 1102 and the second RBAC policy 1104 are semantically equal for all user inputs, the policy deduplication system 112 may consider creating a satisfiability modulo theory (SMT) query, which looks similar to:

(a∈a1∨a∈a2∨ . . . )∧¬(a∈n1∨a∈n2∨ . . . )⇔(a∈a3∨a∈a4∨ . . . )∧¬(a∈n3∨a∈n4∨ . . . )

This formulation describes that if there is a user action “a” that matches any of the allowed actions in the first RBAC policy 1102 and is not disallowed by any of the notactions of the first RBAC policy 1102, then it is also accepted by the second RBAC policy 1104, and vice-versa. As shown, the actions and notactions in the above formula are shown as a query statement and/or expressions. In this form, the expression of “a∈a1” (for an action “a”) means that the “string a” belongs to the language denoted by “a1.” Also, if the above formula holds for all “a,” then both policies are semantically equivalent.

While one way to check for equivalency, solving for the above formula directly with a satisfiability solver model is complex, processor-intensive, and time-consuming. In particular, complexity arises from the extensive logical OR and AND operations, compounded by negations, which contribute to a combinatorial explosion as the policy size increases. Indeed, this approach suffered from complex, nested logical constructs inherent to these policies, which necessitated elaborate and computationally demanding equivalence evaluations. These intrinsic complexities underscore the need for our subsequent optimizations, particularly when comparing larger policies and/or policies on a large scale. As mentioned above, for a pair of larger policies, the comparison process using a satisfiability solver model directly comparing models together often takes around 30 minutes, which is impractical for cloud computing systems with hundreds or thousands of policies.

Accordingly, the policy deduplication system 112 can implement various features and strategies to improve and optimize the comparison process. For instance, in some instances, the policy deduplication system 112 represents actions and notactions with a variable, label, or other abbreviation. In various implementations, the policy deduplication system 112 implements a string compression strategy by assigning unique integers to represent distinct keywords, which allows comparisons to be less complex and quicker to execute. For example, the policy deduplication system 112 allocates lower integer values to more frequently occurring keywords, optimizing compression effectiveness.

As mentioned above, FIGS. 12A-12D provide additional details regarding policies and equivalence check queries, as well as segment counterexample expressions. In particular, FIGS. 12A-12D illustrate example diagrams of breaking down the pair of role-based access control (RBAC) policies to be compared for equivalence according to some implementations. These figures provide additional descriptions regarding the breakdown process, which enables the policy deduplication system 112 to significantly reduce the comparison complexity between two policies.

FIGS. 12A-12D include the first RBAC policy 1102 and the second RBAC policy 1104 introduced above. These figures also include an equivalence check query 1210, a first directional check 1212, and a second directional equivalence check. FIG. 12A shows the initial stages of the policy deduplication system 112 breaking down a pair of policies for an equivalence check. In many implementations, this granular approach significantly improves the performance of a computing processor by localizing the exploration to the most relevant policy aspects.

As mentioned above, the policies include actions and notactions. Furthermore, actions and notactions may be represented with labels. For example, the policy deduplication system uses string compression and/or regular expressions to represent the actions and notactions of the first RBAC policy 1102 and the second RBAC policy 1104 as variables or labels (e.g., a1-a4, n2-n4, and n6 (which was not previously shown)). For ease of explanation, assume that n6 is a label of the second RBAC policy 1104. The pairing of actions to corresponding sets of notactions is described below.

FIG. 12A shows that the policy deduplication system 112 generated an equivalence check query 1210 indicating that the first RBAC policy 1102 is semantically equivalent to the second RBAC policy 1104. This is the query statement or expression that the policy deduplication system 112 is attempting to prove as true or false to determine equivalency.

As shown, the equivalence check query 1210 includes “P1” and “P2” representing the first RBAC policy 1102 and the second RBAC policy 1104, respectively. In many implementations, as part of generating the equivalence check query 1210, the policy deduplication system 112 first converts each policy into an expression (e.g., a regular expression).

To elaborate, in various implementations, the policy deduplication system 112 encapsulates each policy into a policy expression based on its actions and notactions using a regular expression framework. For instance, the policy deduplication system 112 constructs a first expression (e.g., regular expression) for the first RBAC policy 1102, denoted as P1=((a1∨a2∨ . . . )∧¬(n1∨n2∨ . . . )) and a second expression for the second RBAC policy 1104, denoted as P2=((a3∨a4∨ . . . )∧¬(n3∨n4∨ . . . )). Upon generating the first policy expression (P1) and the second policy expression (P2), the policy deduplication system 112 can easily generate the equivalence check query 1210 as P1⇔P2. In many implementations, this approach yields improved performance compared to the approach described above in connection with FIG. 11. In particular, in these instances, the policy deduplication system 112 streamlines the computational process by reducing the complexity inherent in the initial direct comparisons.

As shown in FIG. 12A, the policy deduplication system 112 initiates the breakdown process. For example, in various implementations, the policy deduplication system 112 reduces the equivalence check query 1210 (e.g., policy equivalence query) into more manageable segments using a divide-and-conquer strategy. To illustrate, the policy deduplication system 112 separates, dissects, and/or deconstructs the equivalence check query 1210 (i.e., P1⇔P2) into two directional checks, shown as a first directional check 1212 (i.e., P1→P2) and a second directional check 1214 (i.e., P2→P1). P1→P2 means that P1 implies P2 or that inputs to P1 result in the same outputs as if the inputs were provided to P2. In some cases, P1→P2 does not equal P2→P1.

With the two directional checks, the policy deduplication system 112 first checks the first directional check 1212 for equivalence and, if upheld, proceeds to the second directional check 1214 (or vice versa). However, if the first directional check 1212 fails, then the policy deduplication system 112 may immediately conclude that P1 and P2 are not equivalent and circumvent the need for the reverse check of the second directional check 1214.

In various implementations, the policy deduplication system 112 may further streamline the comparison process by dividing up the policies. Indeed, in many instances, the policy deduplication system 112 separates each policy expression into a set of multiple segments (e.g., segment expression). To illustrate, FIG. 12B shows further dissecting the first directional check 1212. FIGS. 12C (discussed further below) shows additional segments for the first policy expression.

In one or more implementations, the policy deduplication system 112 generates a set of multiple segments for a policy expression by restructuring the segments according to actions and notactions. For example, for each action (“a”), the policy deduplication system 112 identifies a set of notactions (“n”). In some implementations, an action correlates to a set of notactions that includes zero notactions. To illustrate, FIG. 12B includes a first segment 1222 that includes a first action 1218 and a first set of notactions 1220 corresponding to the first action 1218. For ease of explanation, the RBAC policies show the correlation between segment, actions, and notactions, where the third action correlates to multiple notactions (e.g., a1: [n1], a2: [n2], a3: [n4, n6], a4: [n3]).

As shown in FIG. 12B, the policy deduplication system 112 generates a first segment counterexample expression 1216 for the first segment 1222. To elaborate, for each segment, the policy deduplication system 112 generates a counterexample expression of the segment that misaligns with the second policy expression. If a counterexample is found, the segment counterexample expression is valid (e.g., true) and the policies are not equivalent. In many implementations, the policy deduplication system 112 uses a symbolic abstraction model and a satisfiability solver model to search for a counterexample, which is further described in connection with FIGS. 13A-13D.

FIG. 12B illustrates that the first segment counterexample expression 1216 (i.e., a1 && !n1 && !P2) includes an expression that adheres to the first action 1218 (i.e., “a1”), diverges from the first set of notactions 1220 (i.e., “!n1”), and does not align with the second policy expression (i.e., “!P2”). Thus, to satisfy the first segment counterexample expression 1216, the first action 1218 must be valid, the first set of notactions 1220 must be invalid, and the second policy expression must also be invalid. In other words, to satisfy the first segment counterexample expression 1216, the policy deduplication system 112 determines some example input (called a counterexample) that is permitted by an action in P1 but rejected by P2, which would result in P1→P2 being invalid.

However, if no examples surface, the policy deduplication system 112 advances to the next segment corresponding to a subsequent action and its associated notaction set. To illustrate, FIG. 12C shows a second segment counterexample expression 1226 corresponding to the second action (“a2”) in the first RBAC policy 1102. The policy deduplication system 112 checks the second segment counterexample expression 1226 for a counterexample that proves the segment counterexample expression. If not, the policy deduplication system 112 continues the procedure for each segment/action in the first RBAC policy 1102 as long as no counterexamples emerge for P1→P2, validating the assertion.

The policy deduplication system 112 then applies the same approach for the second directional check 1214 of P2→P1, as shown in FIG. 12D. For example, the policy deduplication system 112 generates a second set of multiple segments for the second policy. In some implementations, the policy deduplication system 112 does not generate the second set of segments until the first directional check 1212 is validated. In these implementations, the policy deduplication system 112 saves on processing if the first directional check 1212 is found to be invalid.

To illustrate, FIG. 12D shows the second directional check 1214 further dividing the query into a third segment counterexample expression 1228 and a fourth segment counterexample expression 1230. If any of these counterexamples yield a valid counterexample, the policy deduplication system 112 invalidates the second directional check 1214. Otherwise, if each segment and counterexample yields no counterexamples, then P2→P1 is valid and the equivalence check query 1210 is valid.

As mentioned above, FIGS. 13A-13D provide additional details regarding the use of a symbolic abstraction model and a satisfiability solver model to search for a counterexample for counterexample segments. For example, FIGS. 13A-13D illustrate example diagrams for using the policy deduplication system to determine duplicate policies according to some implementations. In particular, FIG. 13A includes components and elements involved in an RBAC policy equivalence check. FIGS. 13B-13D show sequence diagrams for performing an RBAC policy equivalence check.

FIG. 13A includes the policy deduplication system 112, the symbolic abstraction model 120, and the satisfiability solver model 130, as introduced above. For example, the symbolic abstraction model 120 is a model from the symbolic abstraction models 320, and the satisfiability solver model 130 is a model from the satisfiability solver models 330. FIG. 13A also includes a first policy 1302 and a second policy 1304 (e.g., RBAC policies).

As also shown, the policy deduplication system 112 generates a policy equivalence result 1308 from the first policy 1302 and the second policy 1304 using the symbolic abstraction model 120 and the satisfiability solver model 130 based on counterexample segment expressions 1305 and counterexample results 1306. The policy equivalence result 1308 may indicate whether the first policy 1302 and the second policy 1304 are duplicate policies 1310 or not duplicate policies 1312.

With the components and elements in place, FIGS. 13B-13D provide additional detail on how the components interact to determine the policy equivalence result (e.g., duplicate or not duplicate policies). As shown, FIGS. 13B-13D include communication between the policy deduplication system 112, the symbolic abstraction model 120, the satisfiability solver model 130, and a client device 350. The client device 350 is provided for additional context.

FIG. 13B includes a series of acts 1300 performed by (or for) the policy deduplication system 112. As shown, the series of acts 1300 includes act 1320 of the policy deduplication system 112 identifying a set of policies to be checked for duplicates. For example, the policy deduplication system 112 receives a request from the client device 350 to check for one or more duplicates in a pool of RBAC policies. In some instances, an administrator on the client device 350 provides a request or sets up a recurring script for the policy deduplication system 112 to perform an equivalence check among the RBAC policies.

Act 1322 includes the policy deduplication system 112 generating policy expressions for a first policy and a second policy. For example, the policy deduplication system 112 identifies the first policy 1302 and the second policy 1304 in the set of policies. In addition, the policy deduplication system 112 determines policy expressions for each policy. As described above, a policy expression may include a regular expression of the actions and notactions included in a policy (e.g., P1=((a1∨a2∨ . . . )∧¬(n1∨n2∨ . . . ))).

Act 1324 includes the policy deduplication system 112 generating an equivalence check query between the first policy and the second policy using the policy expressions. For example, the policy deduplication system 112 generates an equivalence check query of P1⇔P2, where P1 is the first policy expression for the first policy 1302 and P2 is the second policy expression from the second policy 1304, as described above.

Act 1326 includes the policy deduplication system 112 dividing the equivalence check query into two directional checks (e.g., sub-queries) between the first policy expression and the second policy expression. For example, the policy deduplication system 112 generates a first directional check of P1→P2 and a second directional check of P2→P1 from the equivalence check query, as described above.

Act 1328, as shown, includes the policy deduplication system 112 initiating verification of the first directional check by breaking down the first directional check into segments. For example, in various implementations, the policy deduplication system 112 generates a set of multiple segments for the first policy 1302. As described above, segments may correspond to actions and associated notactions from a policy.

Act 1330 includes the policy deduplication system 112 generating a counterexample for each segment with the second policy expression. For example, as described earlier, the policy deduplication system 112 generates a first segment counterexample expression for a first action and a first set of notactions in the first policy expression compared to the second policy expression as a whole (e.g., a1 && !n1 && !P2), which questions whether some input exists that produces different output between the two policies. The policy deduplication system 112 may generate a segment counterexample expression for each segment of the first policy expression.

Act 1332 includes the policy deduplication system 112 providing a counterexample segment expression to the symbolic abstraction model 120. For example, the policy deduplication system 112 sends the segment counterexample expression to the symbolic abstraction model 120 with instructions to generate a symbolic version of the segment expression. The policy deduplication system 112 may also use the symbolic abstraction model 120 to generate a satisfiability function representation of the expression.

To illustrate, act 1334 includes the symbolic abstraction model 120 encoding a symbolic counterexample expression of the policy. In various implementations, encoding or generating a symbolic segment counterexample expression includes writing the segment counterexample expression in a common and intermediate language that connects back to multiple source languages. In one or more implementations, the symbolic abstraction model 120 provides enhanced expressive capabilities and adept management of grammatical intricacies to generate a symbolic segment counterexample expression.

Act 1336 includes the symbolic abstraction model 120 converting the symbolic segment counterexample expression into a satisfiability function representation. In various implementations, as described above, the symbolic abstraction model 120 generates a satisfiability function representation by converting the symbolic segment counterexample expression from a high-level common language expression to a low-level SMT (satisfiability modulo theory) model-specific function (e.g., a format compatible with SMT solvers).

Act 1338 includes the symbolic abstraction model 120 providing the satisfiability function representation to the satisfiability solver model 130. For example, the policy deduplication system 112 instructs the symbolic abstraction model 120 to directly provide the satisfiability function representation to the satisfiability solver model 130. In some implementations, the symbolic abstraction model 120 provides the satisfiability function representation to the policy deduplication system 112, which then provides it to the satisfiability solver model 130.

In FIG. 13B, act 1340 includes the satisfiability solver model 130 solving the satisfiability function representation to identify a counterexample. In various implementations, the satisfiability solver model 130 is an SMT solver that evaluates the satisfiability of the satisfiability function. A satisfactory result indicates the presence of a counterexample that indicates some input (e.g., user requirement input) that adheres to an action of the first policy 1302, does not adhere to the corresponding set of notactions, and does not adhere to (e.g., is invalid or false) the second policy 1304. For example, the satisfiability solver model 130 intelligently iterates through different input combinations to determine one or more combinations of inputs that satisfy the provided satisfiability function.

When the satisfiability solver model 130 solves the satisfiability function representation by finding a counterexample, the satisfiability solver model 130 may associate the corresponding user requirement inputs with the counterexample. The user requirement inputs provide at least one concrete example of inputs that will satisfy one policy but not satisfy the other policy. In some implementations, the satisfiability solver model 130 identifies multiple user requirement inputs and/or a range of user requirement inputs.

The series of acts 1300 continues in FIG. 13C, which includes act 1338 and act 1340 for visual continuity. As shown in FIG. 13C, act 1342 includes repeating the counterexample search for each segment of the first policy expression to verify the first directional check, unless a counterexample is found. For example, the policy deduplication system 112 subsequently provides each segment of the first policy expression to the symbolic abstraction model 120, which generates a symbolic version and a satisfiability function representation. The satisfiability solver model 130 then solves the satisfiability function representation for a counterexample. The process repeats through every segment of the first policy expression unless a counterexample is found.

Act 1344 includes verifying, if the first directional check did not identify any counterexamples, the second directional check by breaking down the second policy expression into segments and searching for a counterexample against the first policy expression unless a counterexample is found. For example, the policy deduplication system 112 repeats the breakdown process described above by providing each segment of the second policy expression to the symbolic abstraction model 120, which generates a symbolic version and a satisfiability function representation. Again, the satisfiability solver model 130 then solves for a counterexample. The process repeats through every segment of the second policy expression unless a counterexample is found.

In FIG. 13C, act 1346 includes the policy deduplication system 112 determining that the two policies are semantically equivalent based on no counterexample being found. As described earlier, no counterexample indicates that the first policy 1302 and the second policy 1304 are semantically equal for all user inputs.

Act 1347 includes the policy deduplication system 112 removing the duplicate policy. In various implementations, the policy deduplication system 112 removes one of the two policies. In some implementations, the policy deduplication system 112 flags the policies as duplicates for review and/or manual removal. In some instances, act 1347 is omitted.

Act 1348 includes the policy deduplication system 112 providing an indication of the removed policy to the client device 350. In various implementations, the policy deduplication system 112 indicates the removed policy as part of a report of identified duplicate policies. In cases where the duplicate policy is not automatically removed, act 1348 may include providing an indication that one or both of the two policies are duplicates.

While FIGS. 13B and 13C illustrate an example of failing to identify a counterexample, FIG. 13D illustrates an example of non-equivalent policies. FIG. 13D includes a series of acts 1350 that includes the initial acts from the series of acts 1300 described in connection with FIG. 13B. For example, the series of acts 1350 in FIG. 13D includes acts 1320-1338, as previously described.

In FIG. 13D, the series of acts 1350 includes act 1352 of the satisfiability solver model 130 solving the satisfiability function representation to identify a counterexample. As mentioned above, the satisfiability solver model 130 may be an SMT solver that evaluates the satisfiability of a segment counterexample expression. The satisfiability solver model 130 identifies, finds, or calculates a counterexample and corresponding inputs when it solves the satisfiability function representation to produce a satisfactory result. As mentioned, in various instances, the satisfiability solver model 130 intelligently iterates through different input combinations to determine a combination of one or more inputs that satisfies the provided satisfiability function.

Act 1354 includes the satisfiability solver model 130 returning the counterexample. For example, the policy deduplication system 112 receives a negative counterexample indication from the satisfiability solver model 130. In some implementations, the policy deduplication system 112 also provides the counterexample and/or the user requirement input.

Act 1356 includes the policy deduplication system 112 determining that the two policies are not duplicates based on receiving the counterexample. For example, the counterexample provides that some user input may yield different outputs with the two policies. Act 1358 includes the policy deduplication system 112 providing a report of the current policies to the client device 350. For example, the policy deduplication system 112 indicates which policies in a policy pool are duplicates and/or have been (or will be) automatically removed.

As mentioned previously, the policy deduplication system 112 reduces the complexity of comparing policies for equivalency, significantly decreasing the computing resources and time needed to execute an equivalence check. To illustrate, the inventors compared equivalence checks using different approaches between large policies. As a comparison, the inventors measured the time needed to complete the check. Using the approach of existing systems, the equivalence check took around 30 minutes, as mentioned above. Using the breakdown approach described above, the equivalence check took around 3 seconds. When testing small policies, the existing systems approach took 0.5 seconds while the breakdown approach took 0.031 seconds, which further proves these results hold across different policy sizes.

As mentioned above, short processing time equates to a reduction in processing power needed. Furthermore, this optimization process allows for equivalence checks to be executed in real time, enabling immediate insights and actions. These improvements are pivotal, especially in dynamic network environments like cloud services, where security posture and efficient resource management are paramount, where even slight delays can cascade into significant vulnerabilities or resource management bottlenecks.

To illustrate, the inventors ran the policy deduplication system on an RBAC policy set of 1095 policies and quickly discovered 141 duplicate policies, which accounts for over 12% of the policies. Thus, the policy deduplication system found that 141 RBAC policies could be removed to free up space for new, unique policies. Furthermore, by removing these duplicate policies, the RBAC management system and/or the cloud computing system has 141 fewer policies to check incoming user requests against, resulting in significant savings in computing costs as thousands or even millions of requests are received daily.

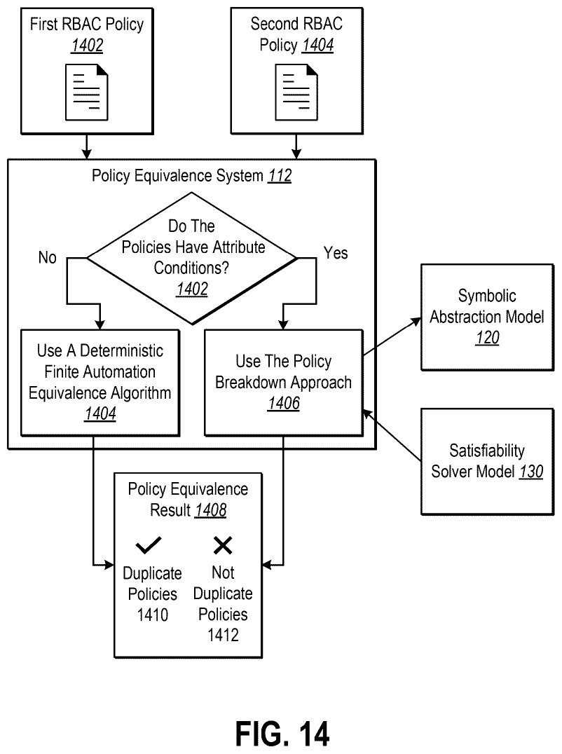

FIG. 14 illustrates an example diagram of the policy deduplication system determining when to use a deterministic finite automaton (DFA) algorithm to test for duplicate policies according to some implementations. As shown, FIG. 14 includes many components and elements previously introduced, such as the first RBAC policy 1102, the second RBAC policy 1104, the policy deduplication system 112, the symbolic abstraction model 120, and the satisfiability solver model 130.

To elaborate, in various implementations, the policy deduplication system 112 implements a hybrid model that leverages both the policy breakdown approach described above and the DFA approach. For example, for policies that include certain conditions, the policy deduplication system 112 utilizes the policy breakdown approach for a detailed analysis. When encountering policies without conditions, the policy deduplication system 112 utilizes the DFA approach for a rapid equivalence evaluation. In these implementations, this dual approach significantly bolsters performance, ensuring both thoroughness and speed by adapting to the specific attributes of each policy comparison, while ensuring highly accurate results.

To illustrate, the policy deduplication system 112 in FIG. 14 shows a state-like diagram of one example hybrid model for determining whether to apply a DFA algorithm or use the breakdown approach when performing an equivalence check between two policies. To illustrate, the policy deduplication system 112 determines (i.e., decision 1402) whether the first RBAC policy 1102 and the second RBAC policy 1104 have attribute conditions. For example, the policy deduplication system 112 analyzes the two policies to identify any attribute-based access control (ABAC) conditions, which were described above.

If the policies are devoid of attribute conditions, the policy deduplication system 112 determines to use a DFA equivalence algorithm, shown as act 1404. Otherwise, if one of the policies includes an attribute condition, the policy deduplication system 112 determines to use the policy breakdown approach 1406 (e.g., the breakdown symbolic counterexample search approach described above, which includes using the symbolic abstraction model 120 and the satisfiability solver model 130).

Regarding the DFA equivalence algorithm, in various implementations, the policy deduplication system 112 performs a preprocessing step by converting actions and notactions into regular expressions, as described above. For example, for the first RBAC policy 1102, the policy deduplication system 112 generates the expression string “P1=((a1∥a2∥ . . . ) && !(n1∥n2 . . . ))” and “P2=((a3∥a4∥ . . . ) && !(n3∥n4 . . . ))” for the second RBAC policy 1104.

In various implementations, the policy deduplication system 112 applies the DFA equivalence algorithm to the policy expression strings. For example, the DFA equivalence algorithm is a deterministic finite-state machine used to determine whether the first RBAC policy 1102 is equivalent to the second RBAC policy 1104.

While the DFA equivalence algorithm is highly efficient, it can only be applied if both policies do not have attribute conditions. In the evaluations described just before this figure, the inventors also tested policy equivalence using the DFA equivalence algorithm approach on large and small policies. They found that the DFA equivalence algorithm approach took 0.16 seconds for large policies and 0.00087 seconds for small policies, although a few seconds were needed for preprocessing each policy.

As shown in FIG. 14, the policy deduplication system 112 outputs the policy equivalence result 1408, indicating whether the first RBAC policy 1102 and the second RBAC policy 1104 are duplicate policies 1410 or not duplicate policies 1412. The policy equivalence result 1408 can be achieved using either the DFA equivalence algorithm approach or the policy breakdown approach.

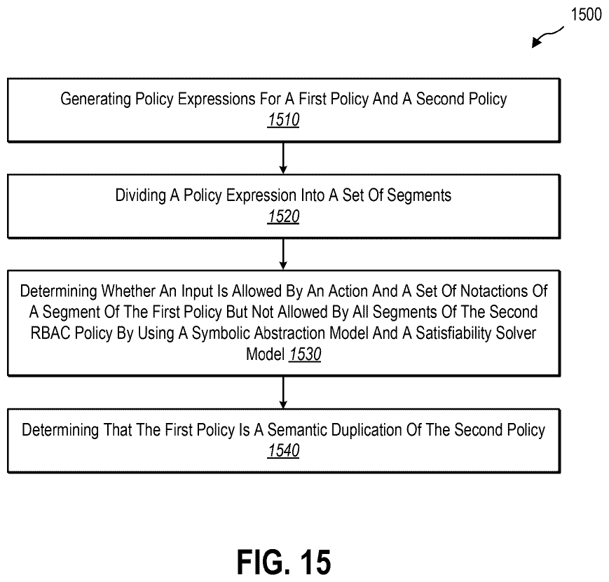

Turning now to FIG. 15, this figure illustrates an example series of acts in a computer-implemented method for determining policy equivalence in role-based access control (RBAC) policies according to some implementations. While FIG. 15 illustrates acts according to one or more implementations, alternative implementations may omit, add, reorder, and/or modify any of the acts shown. In particular, FIG. 15 includes a series of acts 1500, which may be performed by the policy deduplication system and/or the RBAC management system,

The acts in FIG. 15 can be performed as part of a method (e.g., a computer-implemented method). Alternatively, a computer-readable medium can include instructions that, when executed by a processing system with a processor, cause a computing device to perform the acts in FIG. 15. In some implementations, a system (e.g., a processing system comprising a processor) can perform the acts in FIG. 15. For example, the system includes a processing system and a computer memory including instructions that, when executed by the processing system, cause the system to perform various actions or steps.

As shown, the series of acts 1500 includes act 1510 of generating policy expressions for a first policy and a second policy. For instance, in example implementations, act 1510 involves generating a first policy expression for a first RBAC policy and a second policy expression for a second RBAC policy. In various implementations, act 1510 involves generating a first policy expression for a first policy and a second policy expression for a second policy. In some implementations, act 1510 includes identifying the first RBAC policy and the second RBAC policy from a set of RBAC policies on a cloud computing system. In some cases, the first policy expression includes any action in the first RBAC policy being true combined with all notactions in the first RBAC policy being false.

In one or more implementations, act 1510 includes generating an equivalence check query between the first policy expression and the second policy expression upon generating the first policy expression and the second policy expression, and separating the equivalence check query into a first directional check from the first policy expression to the second policy expression and a second directional check from the second policy expression to the first policy expression before dividing the first policy expression into the first set of multiple segments.

As further shown, the series of acts 1500 includes act 1520 of dividing a policy expression into a set of segments. For instance, in example implementations, act 1520 involves dividing the first policy expression into a first set of multiple segments including a first segment, where the first segment pairs a first action in the first RBAC policy with a first set of notactions in the first RBAC policy.

In one or more implementations, act 1520 involves dividing the first policy expression into multiple segments including a first segment. In some instances, dividing the first policy expression into the first set of multiple segments includes generating a segment for each action in the first RBAC policy, wherein each action includes a corresponding set of one or more notactions from the first RBAC policy. In various implementations, the first policy expression is a regular expression of actions and notactions included in the first RBAC policy. In some instances, the first segment includes the first action and does not include other actions from the first RBAC policy.

As shown, the series of acts 1500 includes act 1530 of determining whether an input is allowed by an action and a set of notactions of a segment of the first policy but not allowed by all segments of the second RBAC policy by using a symbolic abstraction model and a satisfiability solver model. For instance, in some implementations, act 1530 involves determining whether there is a counterexample input that is allowed by the first action and the first set of notactions in the first segment of the first policy expression but not allowed by all segments of the second RBAC policy by using a symbolic abstraction model that generates symbolic counterexample expressions and a satisfiability solver model that solves for counterexamples.

In one or more implementations, act 1530 involves determining that the first segment of the first policy is semantically equivalent to all the segments of the second policy expression using a symbolic abstraction model and a satisfiability solver model. In various implementations, using the symbolic abstraction model includes generating a symbolic counterexample expression that includes the first segment and the second policy expression, and/or using the satisfiability solver model includes solving a satisfiability function representation based on the symbolic counterexample expression.

In various implementations, in connection with act 1530, the symbolic abstraction model generates a first symbolic counterexample expression based on a first counterexample expression indicating that the first action is valid, the first set of notactions is invalid, and the second policy expression is invalid. In some instances, the symbolic abstraction model generates a first satisfiability function representation of the first symbolic counterexample expression to provide the satisfiability solver model. In various implementations, the satisfiability solver model fails to find a counterexample that satisfies the first satisfiability function representation, indicating that the first counterexample expression is false.

In some implementations, act 1530 includes comparing each segment in the first set of multiple segments of the first policy expression with all segments of the second RBAC policy to determine semantic equivalence and determining that the first RBAC policy is the semantic duplication of the second RBAC policy further based on not determining the counterexample input when comparing each segment in the first set of multiple segments.

As shown, the series of acts 1500 includes act 1540 of determining that the first policy is a semantic duplication of the second policy. For instance, in some implementations, act 1540 involves determining that the first RBAC policy is a semantic duplication of the second RBAC policy based on not determining a counterexample input.

In one or more implementations, act 1540 involves determining that the first policy is a duplicate of the second policy based on the first segment of the first policy being semantically equivalent to the second policy expression. In some implementations, act 1540 includes automatically removing the first RBAC policy from a set of RBAC policies based on the first policy expression being semantically equivalent to the second policy expression. In some cases, determining that the first RBAC policy is the semantic duplication of the second RBAC policy includes determining that the first RBAC policy has a different syntax from the second RBAC policy.

In some implementations, the series of acts 1500 includes additional acts. For example, the series of acts 1500 includes dividing the first policy expression into a second segment that pairs a second action of the first RBAC policy with a second set of notactions in the first RBAC policy, determining whether there is a counterexample input that is allowed by the second action and the second set of notactions in the first segment of the first policy expression but not allowed by all segments of the second RBAC policy by using the symbolic abstraction model and the satisfiability solver model, and determining that the first RBAC policy is the semantic duplication of the second RBAC policy further based on not determining the counterexample input.

In one or more implementations, the series of acts 1500 includes determining that the first policy expression is semantically equivalent to all the segments of the second policy expression based on no counterexamples being identified when evaluating the first directional statement and the second directional check. In one or more implementations, evaluating the second directional check includes dividing the second policy expression into a second set of multiple segments that compare actions and corresponding sets of notactions, generating counterexample segment expressions that compare each segment in the second set of multiple segments of the second policy expression with the first policy expression, and determining whether a counterexample exists for any of the counterexample segment expressions using the symbolic abstraction model and the satisfiability solver model.

In various implementations, the series of acts 1500 includes determining that the first RBAC policy and a third RBAC policy each do not include attribute conditions and using a deterministic finite automaton equivalence algorithm to determine that the first RBAC policy and the third RBAC policy are semantically equivalent.

### The Policy Consistency System

As mentioned, this disclosure describes a policy consistency system that determines when RBAC policies are inconsistently implemented across different devices, platforms, services, and environments. For instance, the policy consistency system uses a model-based testing framework to identify cases where user requirement inputs produce different outputs when the policy is implemented in different environments. In some implementations, the policy consistency system utilizes symbolic abstraction models and satisfiability solver models to efficiently identify inconsistencies in the implementation of a policy.

Specifically, the policy consistency system provides advantages and addresses problems in the field with systems, computer-readable media, and computer-implemented methods that use symbolic expressions, abstract policy models, and execution paths, along with various models, to improve RBAC policy management by identifying inconsistencies in RBAC policies. As explained below, the policy consistency system leverages a symbolic abstraction model to create an abstract policy model having a set of execution paths and generate symbolic expressions for the execution paths of a policy. Additionally, the policy consistency system uses a satisfiability solver model to determine user requirement inputs that satisfy example solutions to the execution paths, which the policy consistency system uses to perform model-based testing on different implementations of each execution path.

To illustrate, in one or more implementations, for a given RBAC policy to be tested for implementation consistency, the policy consistency system generates an abstract policy model of the policy using a symbolic abstraction model, which includes a set of execution paths. The policy consistency system also determines a satisfiability function representation for a given execution path of the set of execution paths using the symbolic abstraction model. In response to providing the satisfiability function representation to a satisfiability solver model, the policy consistency system receives an input from the satisfiability solver model that is an example solution to the given execution path. Additionally, the policy consistency system identifies multiple different implementation instances for the given execution path. Based on applying the input to the different implementation instances, the policy consistency system determines whether the first RBAC policy is consistently implemented.

Explained at a high level, some cloud computing systems operate using multiple implementation services, platforms, and/or environments due to internal or external requirements. For example, one portion of a cloud computing system operates using C++ implementations while another portion operates using C# implementations. In these implementations, the RBAC management system must ensure that an RBAC policy is implemented consistently across each implementation instance so that all instances yield consistent outcomes for all user inputs. This is critical to maintaining system reliability. To ensure this uniformity, the RBAC management system uses the policy consistency system to determine when a policy is inconsistently implemented across different instances.

To illustrate, consider a complex policy with several allow and deny definitions, each with multiple permissions. While the policy was verified as valid and executed correctly in some environments, the policy could still have a hidden discrepancy when executed in other environments. For example, when evaluating a user request against the policy in a C# implementation instance, the request was authorized. However, the same request with the same user inputs was rejected when executed against a C++ version.

To elaborate, consider the following five contexts in which implementation discrepancies may arise between C# and C++. These five discrepancies between C++ and C# RBAC implementations include four syntactic inconsistencies and one semantic divergence. While the following focuses on these two programming languages, different combinations of languages, platforms, services, and environments may suffer from similar inconsistency issues when using the same policy and user requirement inputs.

First, implementation instances may differ in attribute handling. For example, in C# and C++, there is a difference in how certain attributes are handled. With some attributes, C# operates with strings while C++ operates with integers. In most cases, this variation does not impact the final output. However, in some cases, this difference in framework causes certain inputs to be non-conforming, resulting in output errors.

Second, implementation instances may be different in certain complex scenarios. For example, if a policy includes multiple role definitions, assignments, and/or permission blocks, different implementation instances may process the policy differently. With C#, invalid ABAC conditions were sometimes not discarded, whereas in C++. While this occurrence is rare due to other stringent validations, this difference caused the C# implementation instance to allow invalid roles while the C++ implementation instance rejected them.

Third, implementation instances may differ in key support variance. For instance, when providing support for keys, C# prioritizes one particular key over another, while C++ is flexible in terms of their priority. Although correctable, this is another nuanced example of how, in some instances, implementation instances differ and produce non-matching results.

Fourth, implementation instances may differ in parsing operations. For example, there is a stark contrast in error handling when parsing scenarios involve certain attributes (e.g., “SomeGUID”). The C# implementation instance exhibited intolerance for non-GUID formatted inputs, while C++ withheld exceptions. Parsing differences between the implementation instances could affect the outputs, making a policy inconsistent across implementations.

Fifth, implementation instances may differ in case sensitivity. For example, in key handling, the implementation instances may handle case sensitivity differently. A C++ implementation instance requires lowercase keys in deny assignment blocks, while the C# implementation instance is flexible with case type. In this example, the discrepancy is caused by using different JSON (JavaScript Object Notation) parsers.

As described in this document, the policy consistency system (and/or other systems of the RBAC management system) delivers several significant technical benefits in terms of improving the efficiency of policy equivalence checking compared to existing systems. Moreover, the policy consistency system provides several practical applications that address problems related to managing and processing RBAC policies in cloud computing systems, including determining when an RBAC policy results in inconsistent outcomes when implemented in different environments. While many technical benefits are described above (especially by using a symbolic abstraction model and a satisfiability solver model), additional benefits and practical applications of the policy consistency system are described below.

For example, in various implementations, the policy deduplication system uses a symbolic abstraction model to generate an abstract policy model for a policy, which allows for generating comprehensive test cases covering each execution path within the policy's abstraction model. Then, the policy deduplication system uses these execution path scenarios to identify example solutions (e.g., inputs) for each case using a satisfiability solver model. With these inputs, the policy deduplication system builds and conducts differential testing across the distinct RBAC implementations (e.g., in C# and C++) within the cloud computing system to identify any inconsistencies.

As mentioned above, RBAC improves the efficient management of RBAC policies within a cloud computing system by detecting policies that yield different results from the same user inputs when implemented in different environments. Identifying nuanced inconsistencies in policies is exceedingly challenging due to the complexity of policies coupled with the vast domain of possibilities of potential user requests. For example, each request can comprise numerous fields, with each field capable of hosting an extensive string of characters. Even using an automated process, identifying implementation inconsistency is a difficult, complex, and challenging process that often goes undetected by existing systems. In contrast, the policy deduplication system uses symbolic abstraction models and satisfiability solver models to quickly and efficiently determine inconsistent policies.

By identifying and addressing inconsistent policies, the policy consistency system improves the accuracy and efficiency of a cloud computing system when evaluating user requests against these policies. The policy deduplication system ensures that a policy yields consistent outcomes irrespective of how or where they are implemented. For example, using the symbolic abstraction model to generate an abstract policy model for a policy negates the need to translate policies and specifications into lower-level SMT constraints. In addition to the computational savings, using the symbolic abstraction model streamlines the testing process by quickly generating multiple different implementations of a given execution path from symbolic expressions of the path.

To elaborate, in various implementations, the policy deduplication system uses the symbolic abstraction model and the satisfiability solver model to symbolically derive all potential user requests subject to evaluating a policy. Because each combination of a user request checked against a policy forms a distinct test case, the policy deduplication system uses the symbolic abstraction model and the satisfiability solver model to quickly generate and solve symbolic expressions within a policy. The policy deduplication system reduces the complexity by intelligently finding one example solution for each execution path of a policy, which is used to test the different implementation instances of a policy (rather than needing to test all inputs for all paths, which is infeasible). This way, the policy deduplication system ensures consistency and reliability across implementations of a policy.

As used in this document, the term “abstract policy model” refers to a model-based representation of an RBAC policy. For example, an abstract policy model is a symbolic representation, such as a symbolic abstraction policy representation. For instance, the abstract policy model provides an abstract map of each logical path of a policy. In various implementations, an abstract policy model is mapped as an RBAC decision-making process, such as in the form of a decision tree, having decision nodes representing policy definition conditions.

In many instances, an abstract policy model includes execution paths that represent how user input is processed by the policy to reach a decision or generate an output. The term “execution path” represents a path within an abstract policy model in which an input travels until a decision or result is generated. In some implementations, an abstract policy model includes a set of execution paths that includes an execution path covering every possible user input while simplifying multiple similar inputs to a common execution path. This way, an abstract policy model includes a symbolic representation of all potential requests against which a given policy is evaluated.

FIGS. 16A-16B illustrate an example overview of a policy consistency system that determines whether policies will be implemented consistently across different devices, platforms, services, and environments according to some implementations. In particular, FIG. 16A illustrates a high-level flow diagram outlining the process of the policy consistency system 114 determining whether an RBAC policy is consistently applied across different implementations. FIG. 16B illustrates a block diagram of the same process, emphasizing the generation of an abstract policy model for the policy.

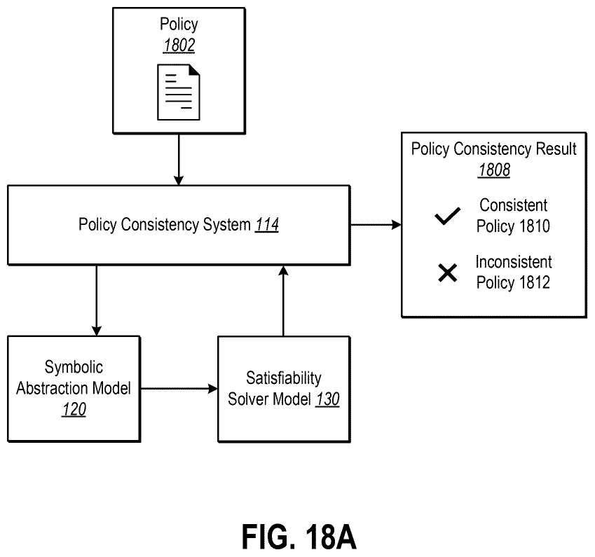

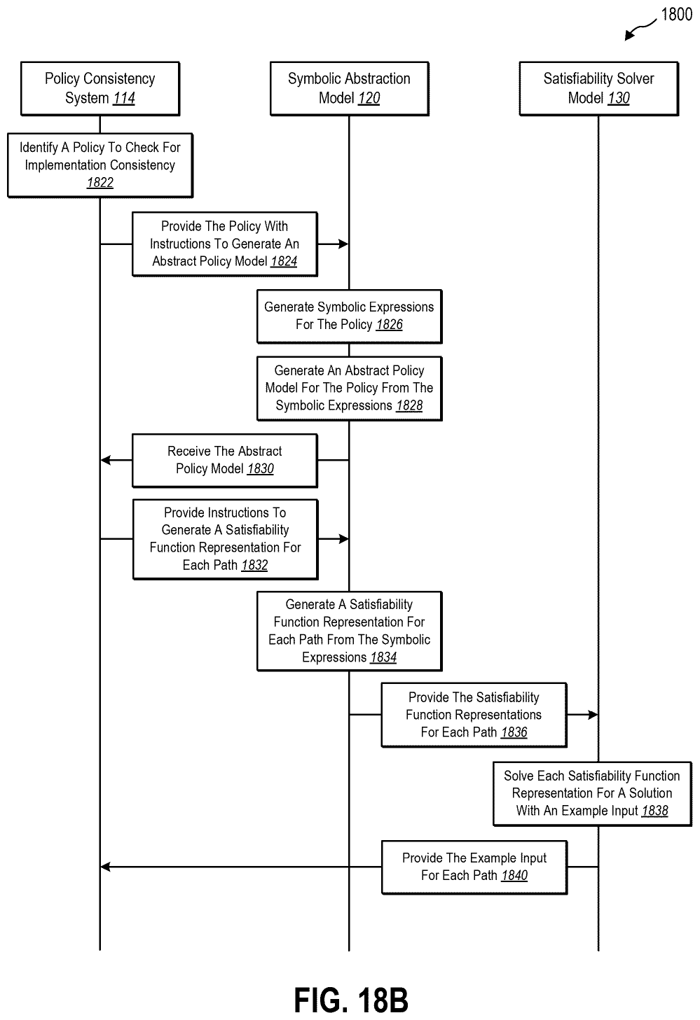

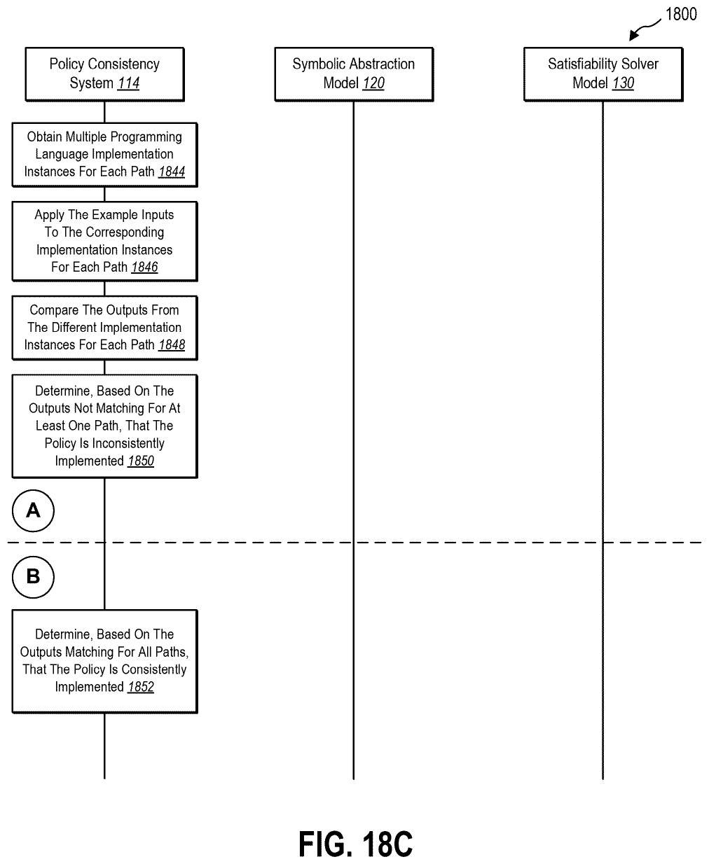

FIG. 16A includes a series of acts 1600 performed by or with the policy consistency system 114 to determine the consistency of the policy when implemented in different environments. As shown, the series of acts 1600 includes act 1602 of the policy consistency system 114 generating an abstract policy model of an RBAC policy. For example, the policy consistency system 114 provides an RBAC policy to a symbolic abstraction model 120 to generate an abstract policy model 1614 of the policy. In various implementations, the symbolic abstraction model 120 uses symbolic representations of the first RBAC policy 1612 to construct the abstract policy model 1614. As shown, the abstract policy model 1614 includes a set of execution paths 1616 corresponding to definitions and effects included in the first RBAC policy 1612 and covering all possible user inputs. Additional details regarding the generation of the abstract policy model are provided below in connection with FIGS. 18A-18C.

Act 1604 includes the policy consistency system 114 determining a satisfiability function representation for a first path. For example, the policy consistency system 114 again uses the symbolic abstraction model 120 to generate a first satisfiability function representation 1620 for the first execution path 1618 of the abstract policy model 1614. If needed, the policy consistency system 114 instructs the symbolic abstraction model 120 to generate satisfiability function representations of the paths in the set of execution paths 1616 of the first RBAC policy 1612 from the abstract policy model 1614. Additional details regarding the generation of satisfiability function representations are provided below in connection with FIGS. 18A-18C.

Act 1606 includes the policy consistency system 114 receiving an input example for the first path. For instance, the policy consistency system 114 provides the first satisfiability function representation 1620 to the satisfiability solver model 130, which solves the function by finding any example that validates the first path (e.g., an example solution 1622). The example solution 1622 is based on an input solution (i.e., a first input 1624), which the satisfiability solver model 130 provides to the policy consistency system 114. The policy consistency system 114 receives the first input 1624, which represents multiple inputs that trigger the first execution path 1618 of the first RBAC policy 1612.

Act 1608 includes identifying multiple implementation instances for the first path in different programming languages. In various implementations, the policy consistency system 114 again uses the symbolic abstraction model 120 to generate various implementations of an execution path in different computer programming languages. For instance, the policy consistency system 114 identifies a first implementation instance 1626 for the first execution path 1618 in a first programming language 1627 and identifies a second implementation instance 1628 in a second programming language 1629. For example, two programming languages, shown as C++ and C#, are maintained on the cloud computing system. The programming languages can include other types of languages.

Act 1610 includes the policy consistency system 114 determining whether the first path is consistently applied across programming languages. For example, the policy consistency system 114 applies the first input 1624 to the first programming language 1627 to obtain a first output 1632. The policy consistency system 114 also applies the first input 1624 to the second implementation instance 1628 to get or obtain a second output 1634.

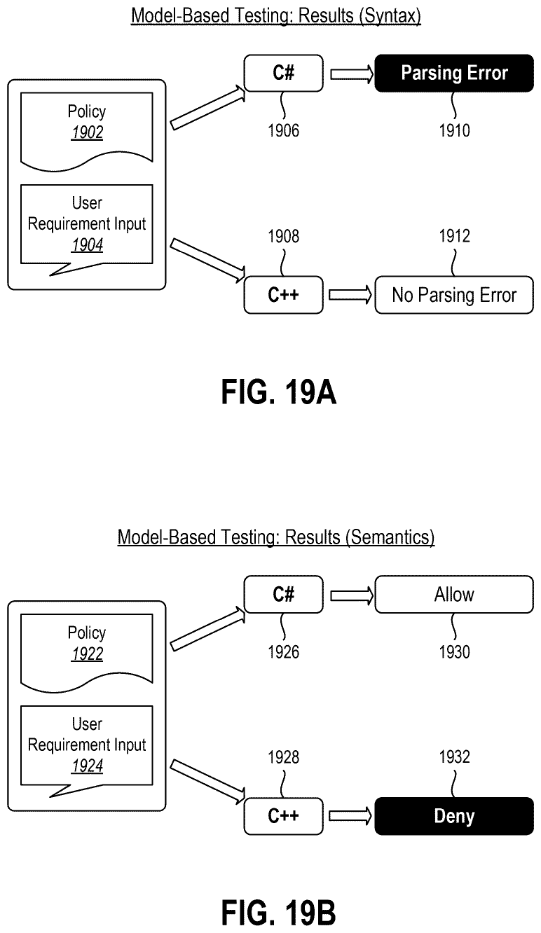

The policy consistency system 114 can compare the two outputs to determine implementation consistency between the two implementation instances. For example, if the first output 1632 and the second output 1634 do not match, the first execution path 1618 is inconsistent, resulting in an inconsistent policy 1638. If the first output 1632 and the second output 1634 match, the first execution path 1618 is consistent (and all other execution paths are also found to match). Then, the policy consistency system 114 determines that the first RBAC policy 1612 is a consistent policy 1636. An inconsistent policy 1638 may trigger additional actions, as discussed below. Additional details regarding matching implementation outputs are provided below in connection with FIGS. 18A-18C and FIGS. 19A-19B.

As mentioned above, FIG. 16B illustrates a block diagram of the same process, emphasizing the generation of an abstract policy model for the policy. As shown, FIG. 16B includes components of the symbolic abstraction model 120 (shown twice) and the satisfiability solver model 130. FIG. 16B also includes elements of the first RBAC policy 1612, the abstract policy model 1614, the first programming language 1627, the second implementation instance 1628, the consistent policy 1636, and the inconsistent policy 1638.

As shown, FIG. 16B includes a series of acts 1650 for the policy consistency system 114 to determine whether a policy is consistent when implemented across a cloud computing system. The series of acts 1650 includes act 1652, where the policy consistency system 114 provides the first RBAC policy 1612 to the symbolic abstraction model 120 to generate the abstract policy model 1614.

Act 1652 also includes the policy consistency system 114 instructing the symbolic abstraction model 120 to generate a symbolic expression for one or more execution paths in the abstract policy model 1614 and/or generating a satisfiability function representation for one or more execution paths.

Act 1654 includes the policy consistency system 114 causing the satisfiability solver model 130 to solve each of the satisfiability function representations for the one or more execution paths of the abstract policy model 1614. For example, the satisfiability solver model 130 determines inputs that result in example solutions to the satisfiability function representations.

Act 1656 includes the policy consistency system 114 obtaining the first implementation instance 1626 and the second implementation instance 1628 (e.g., from the cloud computing system) and applying inputs provided by the satisfiability solver model 130 to the first implementation instance 1626 and the second implementation instance 1628 to generate outputs. It is important to note that the policy consistency system 114 applies the same input to each implementation instance for an execution path. The outputs may be integers, strings, Boolean values, or other expressions.

Act 1658 includes the policy consistency system 114 determining whether the policy is a consistent policy 1636 or an inconsistent policy 1638 by comparing the outputs. For example, the policy consistency system 114 can compare two outputs for an execution path to determine the implementation consistency between the two implementation instances, as described above.

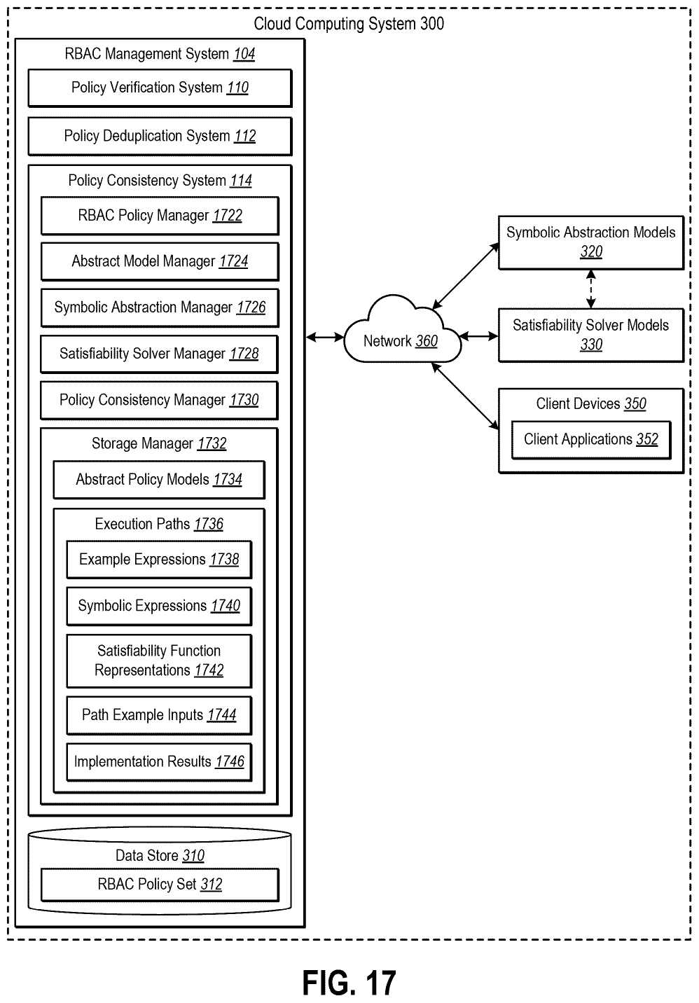

With a general overview in place, additional details are provided regarding the components, features, and elements of the policy consistency system 114. To illustrate, FIG. 17 shows an example computing environment where the policy consistency system is implemented according to some implementations. While FIG. 17 shows example arrangements and configurations of the cloud computing system 300, the RBAC management system 104, the policy consistency system 114, and associated components, other arrangements and configurations are possible. Furthermore, the illustrated components may include additional elements not shown.

In particular, FIG. 17 shows the same cloud computing system provided above in connection with FIG. 3. However, while FIG. 3 described the cloud computing system 300 as a whole and focused on the policy validation system 110, FIG. 17 focuses on the policy consistency system 114. Thus, FIG. 17 builds upon the descriptions of the components and elements previously described (e.g., the RBAC management system 104, the symbolic abstraction models 320, the models 330, and the client device 350) with an added emphasis on the policy consistency system 114.

Turning to the policy consistency system 114 within the RBAC management system 104, the policy consistency system 114 includes various components and elements that are implemented in hardware and/or software. For example, the policy validation system 110 includes an RBAC policy manager 1722, an abstract model manager 1724, a symbolic abstraction manager 1726, a satisfiability solver manager 1728, a policy consistency manager 1730, and a storage manager 1732. The storage manager 1732 includes abstract policy models 1734 and execution paths 1736. As shown, the execution paths include example expressions 1738, symbolic expressions 1740, satisfiability function representations 1742, path example inputs 1744, and implementation results 1746.

Notably, some of the components of the policy consistency system 114 share the same names as components of the policy validation system 110 and the policy deduplication system 112. For example, each of these systems includes a symbolic abstraction manager. In some implementations, the correlating components are the same component and provide the functionality described in each section. In some implementations, the correlating components are different components that perform independent operations. Likewise, in some implementations, the policy validation system 110, the policy deduplication system 112, and the policy consistency system 114 are joined into one system and perform some or all of the operations described in this document.

As mentioned, the policy consistency system 114 includes the RBAC policy manager 1722, which accesses RBAC policies in the RBAC policy set 312 within the data store 310 for the policy consistency system 114. For example, the RBAC policy manager 1722 facilitates the policy consistency system 114 in performing consistency checks on a pool of policies in the RBAC policy set 312.

The policy validation system 110 also includes an abstract model manager 1724, which communicates with the symbolic abstraction model 120 to generate a storage manager 1732 with execution paths 1736 for an RBAC policy. For example, the abstract model manager 1724 instructs the symbolic abstraction model 120 to convert a policy into symbolic expressions and then generates an abstract policy model with a set of execution paths for the policy. In some instances, the abstract model manager 1724 directly generates an abstract policy model for a policy without using the symbolic abstraction model 120 or another model to generate an abstract policy model. In some implementations, the symbolic abstraction manager 1726 works in conjunction with the abstract model manager 1724.

In many implementations, the symbolic abstraction manager 1726 on the policy validation system 110 (and/or implemented on another system) manages communication with the symbolic abstraction models 320. For example, based on execution paths 1736 from an abstract policy model of a policy, the symbolic abstraction manager 1726 instructs a symbolic abstraction model to generate symbolic expressions 1740 and satisfiability function representations 1742 for the execution paths 1736. In some implementations, the symbolic abstraction manager 1726 instructs a symbolic abstraction model to generate multiple implementations of an execution path of an abstract policy model. As noted above, the symbolic abstraction manager 1726 may use a symbolic abstraction model application programming interface (API) to communicate with the symbolic abstraction models 320.

The satisfiability solver manager 1728, located on the policy consistency system 114 (or implemented on another system), manages communication with the satisfiability solver models 330. For instance, the satisfiability solver manager 1728 generates (or causes to be generated) example solutions for the execution paths 1736 based on the satisfiability function representations 1742 of the execution paths 1736. The satisfiability solver manager 1728 may receive path example inputs 1744 for execution paths 1736 from a satisfiability solver model when example solutions are determined for the execution paths 1736.

The policy consistency system 114 includes the policy consistency manager 1730, which determines whether a policy yields consistent outputs across different implementation instances given the same input. For example, the policy consistency manager 1730 (sometimes in connection with the symbolic abstraction manager 1726) causes a symbolic abstraction model to generate multiple implementations of an execution path (e.g., in different programming languages) of an abstract policy model for a policy. The policy consistency manager 1730 can also provide path example inputs 1744 to the different implementation instances to generate their respective outputs.

In addition, the policy consistency manager 1730 compares the outputs to determine implementation results 1746 for each of the execution paths 1736. From the implementation results 1746, the policy consistency manager 1730 determines whether a policy yields consistent or inconsistent results when implemented in different environments.

As shown, the cloud computing system 300 also includes the symbolic abstraction models 320, the models 330, and the client device 350, which were described above in connection with FIG. 3. In some implementations, the client device 350 provides instructions, commands, scripts, and/or programming to implement consistency checks in the RBAC policy set 312 of the cloud computing system 300.

FIGS. 18A-18C illustrate example diagrams of determining implementation consistency for a policy according to some implementations. As mentioned above, these figures provide additional details regarding the generation of the abstract policy model and the generation of the satisfiability function representations. In addition, these figures provide additional detail regarding the use of a symbolic abstraction model and a satisfiability solver model to search for example solution inputs to execution paths of an abstract policy model. In particular, FIG. 18A includes components and elements involved in RBAC policy consistency checks. FIGS. 18B-18C show sequence diagrams for performing an RBAC policy consistency check.

FIG. 18A includes the policy consistency system 114, the symbolic abstraction model 120, and the satisfiability solver model 130, as introduced above. For example, the symbolic abstraction model 120 is a model from the symbolic abstraction models 320, and the satisfiability solver model 130 is a model from the satisfiability solver models 330. FIG. 18A also includes a first policy 1802 (e.g., RBAC policy).

As also shown, the policy consistency system 114 generates a policy consistency result 1808 from the first policy 1802 using the symbolic abstraction model 120 and the satisfiability solver model 130. For example, the policy consistency system 114 determines the policy consistency result 1808 based on an abstract policy model, symbolic expressions, examples, and satisfiability function representations. The policy consistency result 1808 may indicate whether the first policy 1802 is a consistent policy 1810 or an inconsistent policy 1812.

With the components and elements in place, FIGS. 18B-18C provide additional detail on how the components interact to determine the policy consistency result when implemented across a cloud computing system. As shown, FIGS. 18B-18C include communication between the policy consistency system 114, the symbolic abstraction model 120, and the satisfiability solver model 130. In various implementations, these components are located within a cloud computing system.

FIG. 18B includes a series of acts 1800 performed by (or for) the policy consistency system 114. As shown, the series of acts 1800 includes act 1822 of the policy consistency system 114 identifying a policy (e.g., an RBAC policy) to check for implementation consistency. For example, the policy consistency system 114 receives a request from a client device to check a set of policies for implementation consistency. In some instances, the policy consistency system 114 is triggered by a setting or a recurring script for the policy consistency system 114 to perform implementation consistency checks among the RBAC policies. In some implementations, the policy consistency system 114 converts the policy into one or more expressions (as described above) and provides the one or more expressions to the symbolic abstraction model 120 to generate the abstract policy model.

Act 1824 includes the policy consistency system 114 providing the policy with instructions to generate an abstract policy model. For example, the policy consistency system 114 uses the symbolic abstraction model 120 to convert definitions in a policy into a symbolic abstract representation that is easy to analyze and process.

To illustrate, act 1826 includes the symbolic abstraction model 120 generating symbolic expressions for the policy. For example, as described above, the symbolic abstraction model 120 generates one or more symbolic expressions for the policy. As described earlier, generating or encoding a symbolic expression may include writing an expression in a common and intermediate language that connects back to multiple source languages. In one or more implementations, the symbolic abstraction model 120 provides enhanced expressive capabilities and adept management of grammatical intricacies to generate symbolic expressions.

Additionally, act 1828 includes the symbolic abstraction model 120 generating an abstract policy model for the policy from the symbolic expressions. As provided earlier, in various instances, the abstract policy model is a tree model that includes all possible execution paths that cover all possible inputs (e.g., user requirement inputs). The execution paths flow through various decisions (e.g., decision nodes representing policy definition conditions) that are made based on progressing through definitions and effects of the policy. In some instances, the policy consistency system 114 directly generates an abstract policy model for a policy without implementing a symbolic abstraction model.

Act 1830 includes the policy consistency system 114 receiving the abstract policy model from the symbolic abstraction model 120. Upon generating the abstract policy model for the policy, in various implementations, the symbolic abstraction model 120 returns the policy to the policy consistency system 114. In some instances, the policy consistency system 114 implements the symbolic abstraction model 120 and has possession of the abstract policy model upon its creation.

Act 1832 includes the policy consistency system 114 providing instructions to the symbolic abstraction model 120 to generate a satisfiability function representation for each path. Upon receiving the abstract policy model, the policy consistency system 114 may identify different execution paths in the model. For each execution path, the policy consistency system 114 may instruct the symbolic abstraction model 120 to generate a satisfiability function representation from the execution path, as described above. In some instances, the policy consistency system 114 first generates an expression for the executable path, which is provided to the symbolic abstraction model 120 to be converted into a satisfiability function representation.

In some implementations, the policy consistency system 114 provides all of the execution paths to the symbolic abstraction model 120 to be converted into satisfiability function representations. The policy consistency system 114 may instruct one or more symbolic abstraction models to generate multiple execution paths in parallel. In some implementations, the policy consistency system 114 causes the symbolic abstraction model 120 to generate the satisfiability function representations for execution paths of a policy in serial.

Additionally, in various instances, the policy consistency system 114 waits for one execution path to be deemed consistent before providing the next execution path to the symbolic abstraction model 120 to be converted into a satisfiability function representation. This way, if one of the execution paths is found to be inconsistent, the policy consistency system 114 can immediately halt sending any additional execution paths to the symbolic abstraction model 120 as well as halt other actions needed to determine if the additional execution paths are consistent because the policy itself is found to be inconsistent.

Act 1834 includes the symbolic abstraction model 120 generating a satisfiability function representation for each path from the symbolic expressions. As described above, the symbolic abstraction model 120 converts an expression into a satisfiability function representation to solve and find an example solution. In various implementations, as described above, the symbolic abstraction model 120 generates a satisfiability function representation by converting a symbolic expression from a high-level common language expression to a low-level SMT model-specific function (e.g., a format compatible with SMT solvers). As mentioned, the symbolic abstraction model 120 may generate a satisfiability function representation for one execution path at a time and wait for approval from the policy consistency system 114 before processing the next execution path.

Act 1836 includes the symbolic abstraction model 120 providing the satisfiability function representation to the satisfiability solver model 130 for each path. For example, the policy consistency system 114 instructs the symbolic abstraction model 120 to directly provide the satisfiability function representation of one or more execution paths of the policy to the satisfiability solver model 130. In some implementations, the symbolic abstraction model 120 provides the satisfiability function representation to the policy consistency system 114, which then provides it to the satisfiability solver model 130.

In FIG. 18B, act 1838 includes the satisfiability solver model 130 solving each satisfiability function representation for a solution with an example input. In various implementations, the satisfiability solver model 130 is an SMT solver that evaluates the satisfiability of the satisfiability function corresponding to each execution path. A satisfactory result indicates the presence of an example solution that indicates some input (e.g., user requirement input) that adheres to an action of the policy and/or, if included in the path, does not adhere to the corresponding set of notactions of the policy. For example, the satisfiability solver model 130 intelligently iterates through different input combinations to determine one or more combinations of inputs that satisfy the provided satisfiability function.

When the satisfiability solver model 130 solves the satisfiability function representation for an execution path by finding an example solution, the satisfiability solver model 130 may associate the corresponding user requirement inputs with the example solution. The user requirement inputs provide at least one concrete example of inputs that will satisfy the execution path. In some implementations, the satisfiability solver model 130 identifies multiple user requirement inputs and/or a range of user requirement inputs for one or more execution paths. As shown, act 1840 includes the satisfiability solver model 130 providing the example input for each path to the policy consistency system 114.

In FIG. 18C, act 1844 includes the policy consistency system 114 obtaining multiple instances of programming language implementations for each path from the symbolic abstraction model 120. For example, the policy consistency system 114 obtains multiple implementation instances for one or more execution paths stored within the cloud computing system.

Act 1846 includes the policy consistency system 114 applying the example inputs to the corresponding implementation instances for each path. For example, using the first input for a first execution path, the policy consistency system 114 applies the first input to the implementation instances encoded in different languages for the first execution path. Similarly, if necessary, the policy consistency system 114 applies a second input to implementation instances generated for a second execution path from the abstract policy model of the policy.

Applying the inputs to the corresponding implementation instances will generate multiple outputs. The outputs may be values, integers, strings, Boolean values, error codes, acknowledgment messages (ACK), non-acknowledgment messages (NACK), and/or other outputs. For example, the output may be a request allowed message or a request denied message.

Act 1848 includes the policy consistency system 114 comparing the outputs from corresponding implementation instances for each path. For example, for a given execution path, the policy consistency system 114 compares the corresponding outputs to determine whether the outputs match. For instance, the policy consistency system 114 checks whether both outputs for the different implementation instances of a given path result in an “allow” outcome when provided the same input or if one output is “allow” while the other output is “deny.”

Act 1850 includes the policy consistency system 114 determining, based on the outputs not matching for at least one path, that the policy is inconsistently implemented. For example, if any of the execution paths result in non-matching outputs across the different implementation instances, then providing the same input in different implementation environments will yield lead to different outcomes, which is objectionable. Thus, if one execution path yields inconsistent results, it means that the policy itself is inconsistently implemented. At this point, the policy consistency system 114 may immediately terminate and not return to act 1832 or act 1834 to evaluate additional execution paths of the abstract policy model for the policy.

As an alternative to act 1850, FIG. 18C includes act 1852 of the policy consistency system 114 determining, based on the outputs matching for all paths, that the policy is consistently implemented. For instance, whenever the policy consistency system 114 determines matching outputs for different implementation instances of an execution path, the policy consistency system 114 moves on to evaluate the next path.

In some implementations, the policy consistency system 114 goes back to act 1832 or act 1834 to evaluate the next execution path of the abstract policy model for the policy (if paths are evaluated one at a time). If all execution paths have matching outputs, the policy consistency system 114 determines that the policy is consistently implemented. If evaluating multiple paths in parallel, the policy consistency system 114 verifies that each path has matching outputs for its respective implementation instances before determining that the policy is inconsistently implemented.

FIGS. 19A-19B illustrate example diagrams of inconsistent policies according to some implementations. These figures, along with the accompanying descriptions, focus on the type of inconsistencies that the policy consistency system 114 faces when implementing a policy on different platforms and/or environments across a cloud computing system. These examples add to the description above of implementation challenges that arise in some cloud computing systems.

FIGS. 19A-19B provide just two examples of how the same policy with the same inputs differs across multiple implementation instances, which may arise as a result of the separate implementations processing data differently and having different operational standards. As shown, differences can arise in both the semantic and syntactic contexts of RBAC policies. For instance, FIG. 19A includes the policy consistency system detecting syntax differences for a policy implemented in two different programming languages while FIG. 19B includes the policy consistency system detecting semantic differences.

In particular, FIG. 19A includes a policy 1902 and user requirement input 1904. For example, the user requirement input 1904 includes the user identifier attribute in string format. As described above, the policy consistency system 114 may utilize a symbolic abstraction model and a satisfiability solver model to determine an example solution that incorporates the user requirement input 1904 for the policy 1902. FIG. 19A also includes a first implementation instance 1906 and a second implementation instance 1908 of the policy (or a portion of the policy), where the policy is implemented in C# and C++, respectively.

When applying the user requirement input 1904 to the first implementation instance 1906 of the policy 1902, a first output 1910 is generated, shown as a parsing error in FIG. 19A. Applying the user requirement input 1904 to the second implementation instance 1908 of the policy 1902 produces a second output 1912, indicated as no parsing error. Since these outputs do not match, the policy consistency system 114 determines the policy 1902 to be inconsistent.

FIG. 19B provides another example. To illustrate, FIG. 19B includes a policy 1922 and user requirement input 1924. In this case, the policy 1922 may include multiple role assignments and deny assignments with multiple permission blocks. FIG. 19B also includes a first implementation instance 1926 and a second implementation instance 1928 of the policy (or a portion of the policy), where the policy is implemented in C# and C++, respectively.

In FIG. 19B, when applying the user requirement input 1924 to the first implementation instance 1926 of the policy 1922, it results in a first output 1930, shown as allowed. When applying the user requirement input 1924 to the second implementation instance 1928 of the policy 1922, it results in a second output 1932, shown as denied. Again, because these outputs do not match, the policy consistency system 114 determines the policy 1922 to be inconsistent.

In various implementations, when a policy is found to be inconsistent across different implementations, the policy consistency system 114 may employ various corrective measures. For example, the policy consistency system 114 attempts to automatically update the policy to correct the discrepancies. In some instances, depending on the type of inconsistency, the policy consistency system 114 may use heuristics and/or machine learning to update the policy and resolve the issue. Additionally, the policy consistency system 114 can retest the model and apply other verifications (e.g., use the policy validation system 110 to revalidate the policy and ensure it still operates as intended).

In one or more implementations, the policy consistency system 114 prevents the policy from being implemented in a particular environment until it is approved. For example, if the policy is causing an error (e.g., throwing a parsing error) in the C# implementation instance but not in the C++ implementation instance, the policy consistency system 114 permits the policy to operate in the C++ implementation instances while pausing operations of the policy in the C# implementation instances. In some instances, the policy consistency system 114 only pauses operations for inputs that follow the same execution path as the one causing errors.

In some implementations, the policy consistency system 114 flags the policy for inspection. For example, the policy consistency system 114 generates a notice, indication, and/or messages that indicate the inconsistency, the user requirement inputs used, if a particular execution was targeted, and/or the cause of the output mismatch. Based on this information, the policy consistency system 114 enables an administrator to quickly resolve the issue.

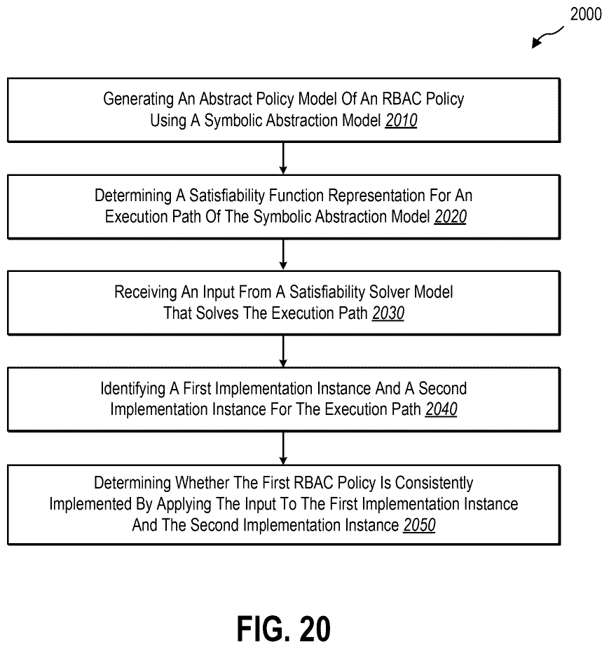

Turning now to FIG. 20, this figure illustrates an example series of acts in a computer-implemented method for determining implementation consistency for one or more role-based access control (RBAC) policies according to some implementations. While FIG. 20 illustrates acts according to one or more implementations, alternative implementations may omit, add, reorder, and/or modify any of the acts shown. In particular, FIG. 20 includes a series of acts 2000, which may be performed by the policy consistency system and/or the RBAC management system.

The acts in FIG. 20 can be performed as part of a method (e.g., a computer-implemented method). Alternatively, a computer-readable medium can include instructions that, when executed by a processing system with a processor, cause a computing device to perform the acts in FIG. 20. In some implementations, a system (e.g., a processing system comprising a processor) can perform the acts in FIG. 20. For example, the system includes a processing system and a computer memory including instructions that, when executed by the processing system, cause the system to perform various actions or steps.

As shown, the series of acts 2000 includes act 2010 of generating an abstract policy model of an RBAC policy using a symbolic abstraction model. For instance, in example implementations, act 2010 involves generating an abstract policy model of a first RBAC policy using a symbolic abstraction model to determine a set of execution paths for the first RBAC policy. In various implementations, the abstract policy model of the first RBAC policy includes an abstraction tree having execution paths that progress through one or more decision nodes representing policy definition conditions. In one or more implementations, the abstract policy model includes execution paths within the set of execution paths that cover all potential inputs to the first RBAC policy.

In some implementations, the first RBAC policy includes both an allow effect and a deny effect, and the abstract policy model includes execution paths (e.g., a third execution path) corresponding to the allow effect and/or the deny effect. In some implementations, the abstract policy model includes a second execution path corresponding to both the allow effect and the deny effect. In some implementations, the abstract policy model includes a second execution path corresponding to both the allow effect and the deny effect. In one or more implementations, the first RBAC policy belongs to a set of RBAC policies maintained by a cloud computing system.

As further shown, the series of acts 2000 includes act 2020 of determining a satisfiability function representation for an execution path of symbolic abstraction model. For instance, in example implementations, act 2020 involves determining a first satisfiability function representation for a first execution path of the set of execution paths using the symbolic abstraction model. In various implementations, act 2020 includes generating the first execution path into a symbolic expression using the symbolic abstraction model before generating the first satisfiability function representation for the first execution path.

As shown, the series of acts 2000 includes act 2030 of receiving an input from a satisfiability solver model that solves the execution path. For instance, in some implementations, act 2030 involves receiving a first input from the satisfiability solver model that is an example solution to the first execution path in response to providing the first satisfiability function representation to the satisfiability solver model. In various implementations, act 2030 includes receiving inputs from the satisfiability solver model for each execution path in the abstract policy model. In some implementations, the satisfiability solver model is a satisfiability modulo theory (SMT) solver.

As shown, the series of acts 2000 includes act 2040 of identifying a first implementation instance and a second implementation instance for the execution path. For instance, in some implementations, act 2040 involves identifying a first implementation instance in a first programming language and a second implementation instance in a second programming language for the first execution path. In many instances, the first programming language is different from the second programming language.

In various implementations, the symbolic abstraction model generates symbolic expressions of execution paths using a common intermediate language that encodes the semantics (e.g., represents the meaning) of multiple source languages. In some implementations, the first implementation instance in the first programming language is obtained from a cloud computing system. In some implementations, the symbolic abstraction model generates or creates the first implementation instance in the first programming language using a first symbolic expression of the first execution path. In some implementations, the first programming language is C++ and the second programming language is C#.

As shown, the series of acts 2000 includes act 2050 of determining whether the first RBAC policy is consistently implemented by applying the input to the first implementation instance and the second implementation instance. For instance, in some implementations, act 2050 involves determining whether the first RBAC policy is consistently implemented by applying the first input to the first implementation instance and the second implementation instance of the first execution path. In some implementations, act 2050 involves determining that the first RBAC policy is inconsistently implemented by applying the first input to the first implementation instance and the second implementation instance of the first execution path.

In one or more implementations, act 2050 includes determining that the first RBAC policy is inconsistently implemented by determining that a first output of the first implementation instance differs from a second output from the second implementation instance. In various implementations, determining whether the first RBAC policy is consistently implemented includes comparing a first output of the first implementation instance that applies the first input with a second output from the second implementation instance that applies the first input.

In some implementations, act 2050 includes determining that the first RBAC policy is not consistently implemented based on the first output of the first implementation instance differing from the second output from the second implementation instance. In some implementations, act 2050 includes determining that the first RBAC policy is consistently implemented based, at least in part, on the first output of the first implementation instance matching the second output from the second implementation instance. In some implementations, act 2050 also includes determining that the first RBAC policy is consistently implemented based on outputs matching across all inputs between implementation instances in the first programming language and the second programming language for each execution path in the abstract policy model of the first RBAC policy.

FIG. 21 illustrates certain components that may be included within a computer system 2100. The computer system 2100 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 2100 represents one or more of the client devices, server devices, or other computing devices described above. For example, the computer system 2100 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 2100 includes a processing system including a processor 2101. The processor 2101 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 2101 may be referred to as a central processing unit (CPU) and may cause computer-implemented instructions to be performed. Although the processor 2101 shown is just a single processor in the computer system 2100 of FIG. 21, in an alternative configuration, a combination of processors (e.g., an ARM and DSP) could be used.

The computer system 2100 also includes memory 2103 in electronic communication with the processor 2101. The memory 2103 may be any electronic component capable of storing electronic information. For example, the memory 2103 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 2105 and the data 2107 may be stored in the memory 2103. The instructions 2105 may be executable by the processor 2101 to implement some or all of the functionality disclosed herein. Executing the instructions 2105 may involve the use of the data 2107 that is stored in the memory 2103. Any of the various examples of modules and components described herein may be implemented, partially or wholly, as instructions 2105 stored in memory 2103 and executed by the processor 2101. Any of the various examples of data described herein may be among the data 2107 that is stored in memory 2103 and used during the execution of the instructions 2105 by the processor 2101.

A computer system 2100 may also include one or more communication interface(s) 2109 for communicating with other electronic devices. The one or more communication interface(s) 2109 may be based on wired communication technology, wireless communication technology, or both. Some examples of the one or more communication interface(s) 2109 include a Universal Serial Bus (USB), an Ethernet adapter, a wireless adapter that operates according to an Institute of Electrical and Electronics Engineers (IEEE) 2102.11 wireless communication protocol, a Bluetooth® wireless communication adapter, and an infrared (IR) communication port.

A computer system 2100 may also include one or more input device(s) 2111 and one or more output device(s) 2113. Some examples of the one or more input device(s) 2111 include a keyboard, mouse, microphone, remote control device, button, joystick, trackball, touchpad, and light pen. Some examples of the one or more output device(s) 2113 include a speaker and a printer. A specific type of output device that is typically included in a computer system 2100 is a display device 2115. The display device 2115 used with implementations disclosed herein may utilize any suitable image projection technology, such as liquid crystal display (LCD), light-emitting diode (LED), gas plasma, electroluminescence, or the like. A display controller 2117 may also be provided, for converting data 2107 stored in the memory 2103 into text, graphics, and/or moving images (as appropriate) shown on the display device 2115.

The various components of the computer system 2100 may be coupled together by one or more buses, which may include a power bus, a control signal bus, a status signal bus, a data bus, etc. For clarity, the various buses are illustrated in FIG. 21 as a bus system 2119.

This disclosure describes a subjective data application system in the framework of a network. In this disclosure, a “network” refers to one or more data links that enable electronic data transport between computer systems, modules, and/or other electronic devices. A network may include public networks such as the Internet as well as private networks. When information is transferred or provided over a network or another communications connection (whether hardwired, wireless, or a combination), the computer considers the connection as a transmission medium. Transmission media can include a network and/or data links that can be used to carry the necessary program code means in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Furthermore, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for determining policy equivalence in role-based access control (RBAC) policies comprising:
generating a first policy expression for a first RBAC policy and a second policy expression for a second RBAC policy;
dividing the first policy expression into a first set of multiple segments including a first segment, wherein the first segment pairs a first action in the first RBAC policy with a first set of notactions in the first RBAC policy;
determining whether there is a counterexample input that is allowed by the first action and the first set of notactions in the first segment of the first policy expression but not allowed by all segments of the second RBAC policy by using a symbolic abstraction model that generates symbolic counterexample expressions and a satisfiability solver model that solves for counterexamples; and
based on not determining a counterexample input, determining that the first RBAC policy is a semantic duplication of the second RBAC policy.

2. The computer-implemented method of claim 1, further comprising automatically removing the first RBAC policy from a set of RBAC policies based on the first policy expression being semantically equivalent to the second policy expression.

3. The computer-implemented method of claim 1, wherein the first policy expression includes any action in the first RBAC policy being true combined with all notactions in the first RBAC policy being false.

4. The computer-implemented method of claim 1, wherein the symbolic abstraction model generates a first symbolic counterexample expression based on a first counterexample expression indicating that the first action is valid, the first set of notactions is invalid, and the second policy expression is invalid.

5. The computer-implemented method of claim 4, wherein the symbolic abstraction model generates a first satisfiability function representation of the first symbolic counterexample expression to provide the satisfiability solver model.

6. The computer-implemented method of claim 5, wherein the satisfiability solver model fails to find a counterexample that satisfies the first satisfiability function representation indicating that the first counterexample expression is false.

7. The computer-implemented method of claim 1, wherein dividing the first policy expression into the first set of multiple segments includes generating a segment for each action in the first RBAC policy, wherein each action includes a corresponding set of one or more notactions from the first RBAC policy.

8. The computer-implemented method of claim 1, wherein the first policy expression is a regular expression of actions and notactions included in the first RBAC policy.

9. The computer-implemented method of claim 1, further comprising:
dividing the first policy expression into a second segment that pairs a second action of the first RBAC policy with a second set of notactions in the first RBAC policy;
determining whether there is a counterexample input that is allowed by the second action and the second set of notactions in the first segment of the first policy expression but not allowed by all segments of the second RBAC policy by using the symbolic abstraction model and the satisfiability solver model; and
based on not determining the counterexample input, determining that the first RBAC policy is the semantic duplication of the second RBAC policy further based on the second segment of the first policy expression being semantically equivalent to the second policy expression.

10. The computer-implemented method of claim 1, further comprising:
comparing each segment in the first set of multiple segments of the first policy expression with all segments of the second RBAC policy to determine semantic equivalence; and
based on not determining the counterexample input when comparing each segment in the first set of multiple segments, determining that the first RBAC policy is the semantic duplication of the second RBAC policy.

11. The computer-implemented method of claim 1, further comprising:
generating an equivalence check query between the first policy expression and the second policy expression upon generating the first policy expression and the second policy expression; and
separating the equivalence check query into a first directional check from the first policy expression to the second policy expression and a second directional check from the second policy expression to the first policy expression before dividing the first policy expression into the first set of multiple segments.

12. The computer-implemented method of claim 11, further comprising determining that the first policy expression is semantically equivalent to all the segments of the second policy expression based on no counterexamples being identified when evaluating the first directional check and the second directional check.

13. The computer-implemented method of claim 12, wherein evaluating the second directional check includes:
dividing the second policy expression into a second set of multiple segments that compare actions and corresponding sets of notactions;
generating counterexample segment expressions that compare each segment in the second set of multiple segments of the second policy expression with the first policy expression; and
determining whether a counterexample exists for any of the counterexample segment expressions using the symbolic abstraction model and the satisfiability solver model.

14. The computer-implemented method of claim 1, further comprising identifying the first RBAC policy and the second RBAC policy from a set of RBAC policies on a cloud computing system.

15. The computer-implemented method of claim 1, further comprising:
determining that the first RBAC policy and a third RBAC policy each do not include attribute conditions; and
using a deterministic finite automaton equivalence algorithm to determine that the first RBAC policy and the third RBAC policy are semantically equivalent.

16. A system for determining policy equivalence in role-based access control (RBAC) policies comprising:
a processing system; and
a computer memory comprising instructions that, when executed by the processing system, cause the system to perform operations of:
generating a first policy expression for a first RBAC policy and a second policy expression for a second RBAC policy;
dividing the first policy expression into a first set of multiple segments including a first segment, wherein the first segment pairs a first action in the first RBAC policy with a first set of notactions in the first RBAC policy;
determining whether there is a counterexample input that is allowed by the first action and the first set of notactions in the first segment of the first policy expression but not allowed by all segments of the second RBAC policy by using a symbolic abstraction model that generates symbolic counterexample expressions and a satisfiability solver model that solves for counterexamples; and
based on not determining a counterexample input, determining that the first RBAC policy is a semantic duplication of the second RBAC policy.

17. The system of claim 16, wherein the first segment includes the first action and does not include other actions from the first RBAC policy.

18. The system of claim 16, wherein determining that the first RBAC policy is the semantic duplication of the second RBAC policy includes determining that the first RBAC policy has a different syntax from the second RBAC policy.

19. A computer-implemented method for determining policy equivalence in role-based access control (RBAC) policies comprising:
generating a first policy expression for a first policy and a second policy expression for a second policy;
dividing the first policy expression into multiple segments including a first segment;
determining whether there is a counterexample input that is allowed by the first segment of the first policy but not allowed by all segments of the second policy using a symbolic abstraction model and a satisfiability solver model; and
based on not determining a counterexample input, determining that the first policy is a duplicate of the second policy.

20. The computer-implemented method of claim 19, wherein:
using the symbolic abstraction model includes generating a symbolic counterexample expression that includes the first segment and the second policy expression; and
using the satisfiability solver model includes solving a satisfiability function representation based on the symbolic counterexample expression.
